(19) United States
(12) Patent Application Publication
(10) Pub. No.: US 2009/0279058 A1
(43) Pub. Date: Nov. 12, 2009

(54) EXPOSURE APPARATUS

(76) Inventor: Noriyasu Hasegawa, Tochigi-ken (JP)

Correspondence Address: ROSSI, KIMMS & McDOWELL LLP., 20609 Gordon Park Square, Suite 150, Ashburn, VA, 20147, US

(21) Appl. No.: 11/720,703

(22) PCT Filed: Mar. 2, 2006
(86) PCT No.: PCT/JP2006/304540

§ 371 Date: Jun. 1, 2007

(30) Foreign Application Priority Data
Mar. 2, 2005 (JP) 2005-057895
May 31, 2005 (JP) 2005-158417
Dec. 28, 2005 (JP) 2005-380283
Feb. 2, 2006 (JP) 2006-026250

(51) Int. Cl. G03B 27/52

(52) U.S. Cl. 355/30

(57) ABSTRACT

An exposure apparatus for immersing, in liquid, a space between a final lens of a projection optical system and a plate, and for exposing the plate via the liquid includes a leak reducer for reducing or preventing a leak of the liquid from an area in which the liquid is to be filled between the final lens of the projection optical system and the plate, and a pressure maintainer provided to the leak reducer or provided closer to an optical axis of the projection optical system than the leak reducer, the pressure maintainer restraining a pressure fluctuation of gas in or near the area, wherein both a liquid recovery port for recovering the liquid from the area and a liquid supply port for supplying the liquid to the area are closer to the optical axis of the projection optical system than the leak reducer and the pressure maintainer.

### TECHNICAL FIELD

The present invention relates generally to an exposure apparatus, and more particularly to a so-called immersion exposure apparatus that immerses, in liquid or fluid, a space between a surface of a plate to be exposed and a final surface of a projection optical system, and exposes the plate via the projection optical system and the liquid.

### BACKGROUND ART

A conventional projection exposure apparatus uses a projection optical system to expose a circuit pattern of a reticle or a mask onto a wafer. A high-resolution exposure apparatus that has a good transfer precision and throughput is increasingly demanded. The immersion exposure is one attractive measure for the high-resolution demands. The immersion exposure promotes a higher numerical aperture (“NA”) of the projection optical system by replacing, with a liquid, a medium between the wafer and the projection optical system. The projection exposure apparatus has an NA of n·sin where n is a refractive index of the medium. The NA increases up to n when the filled medium has a refractive index greater than that of air, i.e., n>1. The immersion exposure intends to reduce the resolution R(R=k₁·(/NA)) of the exposure apparatus, where k₁ is a process constant and is a wavelength of a light source.

A local fill method is proposed for the immersion exposure, which locally fills the liquid in a space between the final surface of the projection optical system and the wafer. See, for example, PCT International Publications Nos. 99/49504 and 2004/086470. The local fill method needs to uniformly flow the liquid in the narrow space between the final surface of the projection optical system and the wafer. For example, when the liquid flows around the contour of the final lens of the projection optical system, gas bubbles are mixed in the liquid. When the wafer moves at a high speed, the liquid disperses and its amount decrease, causing gas bubbles to mix. The gas bubbles cause diffuse reflections of the exposure light, and prevent it from reaching a proper position on the wafer, deteriorating the transfer precision. In addition, the gas bubbles decrease an amount of the exposure light, and lower a throughput.

One proposed solution for this problem is an air curtain method that blows air around the space between the final surface of the projection optical system and the wafer, and keeps the liquid there. See, for example, Japanese Patent Application, Publication No. 2004-289126.

The exposure apparatus in Japanese Patent Application, Publication No. 2004-289126 attempts to restrain liquid's spread only by the air curtain, but the space between the projection optical system and the wafer is so small that the restraint cannot actually be made large. Then, the air curtain's restraint is likely to be weaker than the liquid's spreading force, and the liquid is likely to spread beyond the air curtain. The liquid flows in and clogs a gas recovery port that recovers a gas of the air curtain, extinguishing the air curtain, and causing the gas bubbles to mix in the liquid. The gas bubbles mixed in the liquid are problematic as discussed above. In addition, while the wafer moves from a first exposure area to a second exposure area, the liquid does not perfectly follow the wafer movement due to the insufficient restraint of the air curtain. Then, the liquid is partially torn off and remains on the first exposure area.

The present invention is directed to an exposure apparatus that improves both a transfer precision and a throughput.

### DISCLOSURE OF INVENTION

An exposure apparatus according to one aspect of the present invention for immersing, in liquid, a space between a final lens of a projection optical system and a plate, and for exposing the plate via the liquid includes a leak reducer for reducing or preventing a leak of the liquid from an area in which the liquid is to be filled between the final lens of the projection optical system and the plate, and a pressure maintainer provided to the leak reducer or provided closer to an optical axis of the projection optical system than the leak reducer, the pressure maintainer restraining a pressure fluctuation of gas in or near the area, wherein both a liquid recovery port for recovering the liquid from the area and a liquid supply port for supplying the liquid to the area are closer to the optical axis of the projection optical system than the leak reducer and the pressure maintainer.

A device manufacturing method according to another aspect of the present invention includes the steps of exposing a plate using the above exposure apparatus, and developing the plate that has been exposed.

Other features and advantages of the present invention will be readily apparent from the following description with reference to the accompanying drawings.

### BRIEF DESCRIPTION OF DRAWINGS

FIG. 1 is a schematic sectional view of a structure of an inventive exposure apparatus.

FIG. 2 is a schematic sectional view of a lens barrel in the exposure apparatus shown in FIG. 1.

FIG. 3 is a partially enlarged view of principal part of the lens barrel shown in FIG. 2.

FIG. 4 is a bottom sectional view of the lens barrel shown in FIG. 2.

FIG. 5 is a schematic sectional view of another embodiment of the lens barrel shown in FIG. 2.

FIG. 6 is a schematic sectional view of another embodiment of the lens barrel shown in FIG. 2.

FIG. 7 is a schematic sectional view of another embodiment of the lens barrel shown in FIG. 2.

FIG. 8 is a schematic sectional view of another embodiment of the lens barrel shown in FIG. 2.

FIG. 9 is a schematic sectional view of another embodiment of the lens barrel shown in FIG. 2.

FIG. 10 is a schematic sectional view of another embodiment of the lens barrel shown in FIG. 2.

FIG. 11 is a schematic sectional view of another embodiment of the lens barrel shown in FIG. 2.

FIG. 12 is a schematic sectional view of another embodiment of the lens barrel shown in FIG. 2.

FIG. 13 is a bottom sectional view of the lens barrel shown in FIG. 12.

FIG. 14 is a flowchart for explaining manufacture of devices (such as semiconductor chips such as ICs and LCDs, CCDs, and the like).

FIG. 15 is a detail flowchart of a wafer process as Step 4 shown in FIG. 14.

FIG. 16 is a sectional view showing a detailed configuration applicable to a gas supply part shown in FIG. 2.

FIG. 17 is a sectional view showing a detailed configuration applicable to the gas supply part shown in FIG. 2.

FIG. 18 is a schematic sectional view of another embodiment of the lens barrel shown in FIG. 2.

FIG. 19 is a schematic sectional view of another embodiment of the lens barrel shown in FIG. 2.

FIG. 20 is a schematic sectional view of another embodiment of the lens barrel shown in FIG. 2.

FIG. 21 is a schematic sectional view of another embodiment of the lens barrel shown in FIG. 2.

FIG. 22 is a schematic sectional view of another embodiment of the lens barrel shown in FIG. 2.

FIG. 23 is a schematic sectional view of another embodiment of the lens barrel shown in FIG. 2.

FIG. 24 is a schematic sectional view of another embodiment of the lens barrel shown in FIG. 2.

FIG. 25 is a schematic sectional view of another embodiment of the lens barrel shown in FIG. 2.

FIG. 26 is a schematic sectional view of another embodiment of the lens barrel shown in FIG. 2.

FIG. 27 is a schematic sectional view of another embodiment of the lens barrel shown in FIG. 2.

### BEST MODE FOR CARRYING OUT THE INVENTION

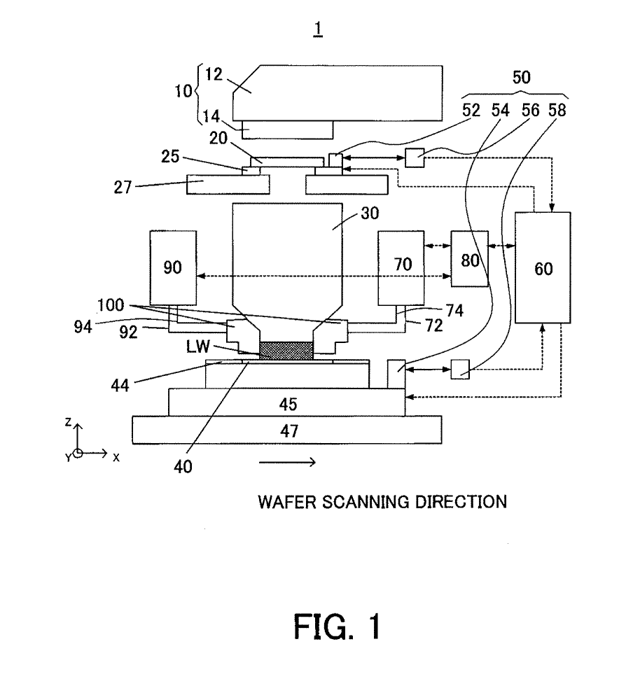

A description will now be given of an exposure apparatus of one embodiment according to one aspect of the present invention with reference to the accompanying drawings. In each figure, like elements are designated by like reference numerals, and a duplicate description will be omitted. Here, FIG. 1 is a schematic sectional view of a structure of the exposure apparatus 1.

The exposure apparatus 1 is an immersion projection exposure apparatus that exposes a circuit pattern of a reticle 20 onto a wafer 40 in a step-and-scan manner, via liquid LW supplied to a space between the wafer 40 and projection optical system 30. The exposure apparatus 1 can also use a step-and-repeat manner.

The exposure apparatus 1 includes, as shown in FIG. 1, an illumination apparatus 10, a reticle stage 25 that supports the reticle 20, the projection optical system 30, a wafer stage 45 that supports the wafer 40, a distance-measuring unit 50, a stage controller 60, a fluid supplier 70, an immersion controller 80, a fluid recoverer 90, and a lens barrel 100.

The illumination apparatus 10 illuminates a reticle 20 that has a circuit pattern to be transferred, and includes a light source unit 12, and an illumination optical system 14.

The light source unit 12 uses as a light source an ArF excimer laser with a wavelength of 193 nm in this embodiment. However, the light source unit 12 is not limited to the ArF excimer laser and may use, for example, a KrF excimer laser with a wavelength of approximately 248 nm, an F₂ laser with a wavelength of approximately 157 nm, a lamp, such as a mercury lamp and a xenon lamp.

The illumination optical system 14 is an optical system that illuminates the reticle 20, and includes a lens, a mirror, an optical integrator, a stop, and the like, for example, in order of a condenser lens, a fly-eye lens, an aperture stop, a condenser lens, a slit and an imaging optical system.

The reticle 20 is fed from the outside of the exposure apparatus 1 by a reticle feed system (not shown), and is supported and driven by the reticle stage 25. The reticle 20 is made, for example, of quartz, and has a circuit pattern to be transferred. The diffracted light emitted from the reticle 20 passes the projection optical system 30, and is projected onto the wafer 40. The reticle 20 and the wafer 40 are located in an optically conjugate relationship. Since the exposure apparatus 1 of this embodiment is a step-and-scan exposure apparatus (scanner), the reticle 20 and the wafer 40 are scanned at a speed ratio of a reduction ratio, thus transferring the pattern on the reticle 20 to the wafer 40. While this embodiment uses the step-and-repeat exposure apparatus (stepper), the reticle 20 and the wafer 40 are maintained stationary during exposure.

The reticle stage 25 is attached to a stool 27 for fixing it. The reticle stage 25 supports the reticle 20 via a reticle chuck (not shown), and its movement is controlled by a moving mechanism (not shown) and the stage controller 60. The moving mechanism (not shown) includes a linear motor, etc., and drives the reticle stage 25 to move the reticle 20 in the XYZ directions.

The projection optical system 30 is an optical system that serves to image the diffracted light from the pattern of the reticle 20. The projection optical system 30 may use a dioptric optical system solely including a plurality of lens elements, and a catadioptric optical system including a plurality of lens elements and at least one mirror, and so on.

The wafer 40 is fed from the outside of the exposure apparatus 1 by a wafer fed system (not shown), and supported and driven by the wafer stage 45. The wafer 40 is a plate to be exposed, and broadly covers a liquid crystal plate and an object to be exposed. A photoresist is applied onto the wafer 40.

A level plate (liquid holder) 44 is located around the wafer 40 and levels between the wafer stage 40 and the outside area (wafer stage 45). The level plate 44 holds the liquid LW, is level with the wafer 40 plane, and enables the liquid LW to be held (or to form a liquid film) outside the wafer 40.

Preferably, the surface of the level plate 44 which contacts the liquid LW is coated with polytetrafluoroethylene (“PTFE”), or provided with a modified layer of PTFE and polyperfluoro alkoxy ethylene, and its copolymer (PFA), and its derivative, such as fluoro-resin and polyparaxylylene (PPX) resin. A PFA material generally has a contact angle of about 100°, but can modify or improve the contact angle by adjusting a polymerization rate or by introducing a derivative or functional group. PPX resin also modifies or improves the contact angle by introducing the derivative or functional group. The surface treatment may use a silane coupling agent, such as silane containing perfluoro alkyl group (heptadecafluorodeccyl silane).

An undulated or acicular fine structure may be formed on the surface of the level plate 44 coated with the fluoro-resin etc. and may adjust the surface roughness. The undulated fine structure on the surface of the level plate 44 enhances a wetness characteristic for a material that has high wettability and lowers the wetness characteristic for a material that has low wettability. In other words, the undulated fine structure on the surface of the level plate 44 can increase an apparent contact angle of the level plate 44.

The wafer stage 45 is attached to a stool 47 for fixing it. The wafer stage 45 supports the wafer 40 via a wafer chuck (not shown). The wafer stage 45 adjusts a position in the longitudinal (vertical or Z-axis) direction, a rotational direction and an inclination of the wafer 40 under control of the stage controller 60. During exposure, the stage controller 60 controls the wafer stage 45 so that the wafer 40 plane (exposure area) always and precisely accords with the focal plane of the projection optical system 30 with high precision.

The distance-measuring unit 50 measures a position of the reticle stage 25, a two-dimensional position of the wafer stage 45 on real-time basis, via reference mirrors 52 and 54, and laser interferometers 56 and 58. A distance measurement result by the distance-measuring unit 50 is transmitted to the stage controller 60, and the reticle stage 25 and the wafer stage 45 are driven at a constant speed ratio under control of the stage controller 60 for positioning and synchronous control.

The stage controller 60 controls driving of the reticle stage 25 and the wafer stage 45.

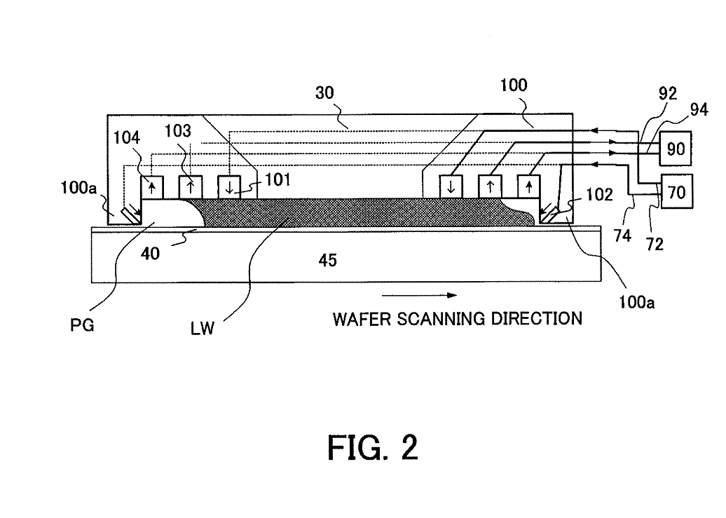

As shown in FIG. 2, the fluid supplier 70 supplies the liquid LW into the space between the projection optical system 30 and the wafer 40, and provides gas PG around the liquid LW. The fluid supplier 70 includes a generator (not shown), a deaerator (not shown), a temperature controller (not shown), a liquid supply tube 72, and a gas supply tube 74. The fluid supplier 70 supplies the liquid LW via a liquid supply port 101 of the liquid supply tube 72 arranged around the final surface of the projection optical system 30, and creates a film of the liquid LW in the space between the projection optical system 30 and the wafer 40. The fluid supplier 70 supplies the gas PG via a gas supply port 102 of the gas supply tube 74 around the liquid LW, forms a gas curtain, and prevents the dispersion of the liquid LW. The space between the projection optical system and the wafer 40 preferably has a thickness, for example, of 1.0 mm or smaller, enough to stably form and remove the film of the liquid LW.

The fluid supplier 70 further includes, for example, a tank that stores the liquid LW or gas PG, a gas compressor that feeds out the liquid LW or gas PG, and a flow controller that controls the supply flow of the liquid LW or gas PG.

Preferably, the liquid LW is selected from a material with a little absorption of the exposure light, and has almost the same refractive index as a dioptric optical element such as quartz and the calcium fluorides. More specifically, the liquid LW can use pure water, function water, organic liquid, liquid fluorides (for example, fluorocarbon), etc. The deaerator (not shown) preferably degasify the liquid LW to sufficiently remove dissolved gas beforehand. The deaerator suppresses generations of gas bubbles, and allows any generated gas bubble to be absorbed in the liquid immediately. For example, the deaerator may target nitrogen and oxygen contained in the air. A removal of 80% of a gas amount dissolvable in the liquid LW would sufficiently suppress the generations of the gas bubbles. The exposure apparatus 1 may have the deaerator, and supply the liquid LW to the liquid supplier 70 while always removing the dissolved gas from the liquid LW.

The generator reduces contaminants, such as metal ions, fine particles, and organic matters, from material water supplied from a material water source, generating the liquid LW. The liquid LW generated by the generator is supplied to the deaerator.

The deaerator degasifies the liquid, and reduces dissolved oxygen and nitrogen in the liquid LW. The deaerator includes, for example, a membrane module and a vacuum pump. The deaerator is preferably an apparatus which, for example, flows the liquid LW from one side of a gas transmitting membrane, and maintains the other side in vacuum, expelling the dissolved gas from the liquid LW through the membrane.

The temperature controller controls the temperature of the liquid LW.

As shown in FIG. 2, the liquid supply tube 72 supplies the liquid LW to the space between the projection optical system 30 and the wafer 40 via the liquid supply port 101 in the lens barrel 100, which will be described later, after the liquid LW is degasified by the deaerator and temperature-controlled by the temperature controller. The liquid supply tube 72 is connected to the liquid supply port 101. Here, FIG. 2 is a schematic sectional view of the liquid supply tube 72 (the lens barrel 100, which will be described later).

The liquid supply tube 72 is preferably made of resin that is less likely to liquate or contaminate the liquid LW, such as PTFE resin, polyethylene resin, and polypropylene resin. When the liquid LW uses liquid other than pure water, the liquid supply tube 72 may be made of a material that is less likely to liquate out and has sufficient durability to the liquid LW.

The gas supply tube 74 is connected to the gas supply port 102 in the lens barrel 100, which will be described later. The gas supply tube 74 supplies the gas PG from the fluid supplier 70, and encloses the surrounding of the liquid LW. The gas supply tube 74 is made of various types of resin and metal, such as stainless steel.

The gas PG prevents the liquid LW from dispersing around the projection optical system 30. In addition the gas PG prevents external gases from dissolving in the liquid LW, and protects the liquid LW from the external environment. The gas PG may use hydrogen and inert gas, such as nitrogen, helium, neon, and argon. The gas PG shields oxygen that negatively affects exposure, reduces the influence on the exposure of the gas PG dissolved in the liquid, and prevents the deterioration of an exposed pattern or exposure precision.

The immersion controller 80 obtains information of the wafer stage 45, such as a current position, speed, acceleration, a target position, and a moving direction, and controls immersion exposure based on the information. The immersion controller 80 provides the fluid supplier 70 and the fluid recoverer 90 with control commands, such as a switch between supplying and recovering of the liquid LW, a supply stop of the supply of the liquid LW, a recovery stop of the liquid LW, and control over the amounts of the supplied or recovered liquid LW.

The fluid recoverer 90 recovers the liquid LW and gas PG that have been supplied by the fluid supplier 70. The fluid recoverer 90 in this embodiment includes a liquid recovery tube 92, and a gas recovery tube 94. The fluid recoverer 90 further includes, for example, a tank that temporarily stores the collected liquid LW or gas PG, an absorber that absorbs the liquid LW and the gas PG, and a flow controller that controls the recovery flow of the liquid LW or gas PG.

The liquid recovery tube 92 recovers the supplied liquid LW from a liquid recovery port 103 in the lens barrel 100, which will be described later. The liquid recovery tube 92 is preferably made of resin that is less likely to liquate out or contaminate the liquid LW, such as PTFE resin, polyethylene resin, and polypropylene resin. When the liquid LW uses a liquid other than pure water, the liquid recovery tube 92 may be made of a material that is less likely to liquate out and has sufficient durability to the liquid LW.

The gas recovery tube 94 is connected to a gas recovery port 104 in the lens barrel 100, which will be described later, and recovers the supplied gas PG. The gas recovery tube 94 is made of various types of resin and metal, such as stainless steel.

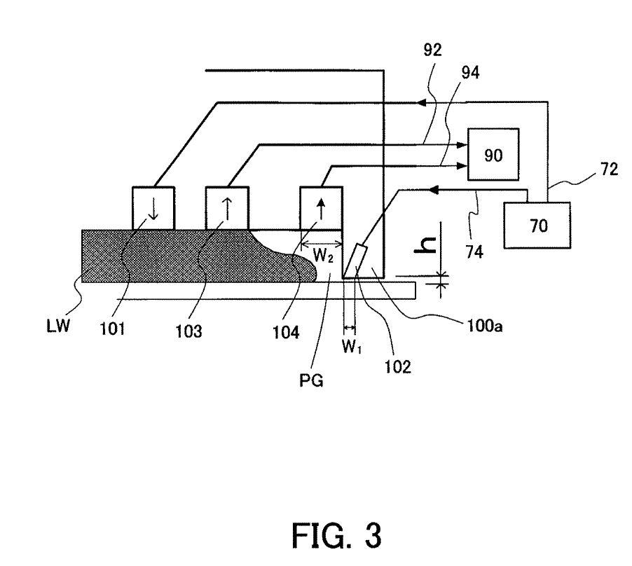

The lens barrel 100 serves to hold the projection optical system 30, and has, as shown in FIG. 3, the liquid supply port 101, the gas supply port 102, the liquid recovery port 103, the gas recovery port 104, and a convex 100a. Here, FIG. 3 is a partially enlarge view of principal part of the lens barrel 100.

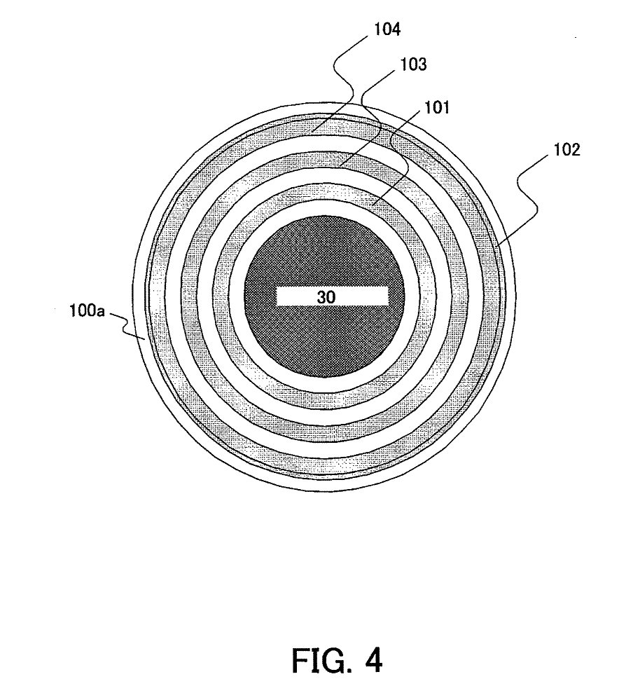

The liquid supply port 101 is an opening that supplies the liquid LW, and connected to the liquid supply tube 72. The liquid supply port 101 opposes to the wafer 40 in this embodiment. The liquid supply port 101 is a concentric opening formed near the projection optical system 30, as shown in FIG. 4. While this embodiment forms the liquid supply port 101 concentrically, it may be formed segmentally. Here, FIG. 4 is a bottom sectional view of the lens barrel 100.

The liquid supply port 101 may be coupled with a porous member, or may be a slit-shaped opening. A sintered fiber or granular (powder) metallic material and inorganic material are particularly suitable for the porous member. The porous member is preferably made of such a material (that forms at least a surface) as stainless steel, nickel, alumina, SiO₂, SiC, and SiC that has SiO₂ only on its surface through a thermal treatment.

The gas supply port 102 is an opening that supplies the gas PG, and connected to the gas supply tube 74. As shown in FIGS. 2 to 4, the gas supply port 102 is a concentric opening provided outside of the liquid supply port 101. While this embodiment forms the gas supply port 102 concentrically, it may be formed segmentally.

The gas supply port 102 may be coupled with a porous member, or may be a slit-shaped opening. A sintered fiber or granular (powder) metallic material and inorganic material are particularly suitable for the porous member. The porous member is preferably made of such a material (that forms at least a surface) as stainless steel, nickel, alumina, SiO₂, SiC, and SiC that has SiO₂ only on its surface through a thermal treatment.

The liquid recovery port 103 is an opening that recovers the supplied liquid LW, and connected to the liquid recovery tube 92. The liquid recovery port 103 can also recover the gas. The liquid recovery port 103 opposes to the wafer 40 in this embodiment. The liquid recovery port 103 has a concentric opening. The liquid recovery port 103 may be coupled with a porous member, such as sponge, or may be a slit-shaped opening. A sintered fiber or granular (powder) metallic material and inorganic material are particularly suitable for the porous member. The porous member is preferably made of such a material (that forms at least a surface) as stainless steel, nickel, alumina, SiO₂, SiC, and SiC that has SiO₂ only on its surface through a thermal treatment. The liquid recovery port 103 is formed, as shown in FIGS. 2 and 4, outside of the liquid supply port 101, and thus the liquid LW becomes less likely to leak to the outside of the projection optical system 30. While this embodiment forms the liquid recovery port 103 concentrically, it may be formed segmentally.

As the liquid LW moves with fast movements of the wafer stage 45, the interface of the liquid LW moves back and forth between the liquid recovery port 103 and the holder. Any step between the liquid recovery port 103 and the holder rolls in gas bubbles, causing an exposure error. As the liquid LW moves with the fast movements of the wafer stage 45, an interface of the liquid LW similarly moves back and forth among the liquid supply port 101, the liquid recovery port 103, and a holder (a bottom surface of the lens barrel 100). Any step among them would roll in gas bubbles, causing an exposure error. Therefore, the liquid supply port 101, the liquid recovery port 103, and the holder are preferably approximately level with each other.

The gas recovery port 104 is an opening that recovers the supplied gas PG, and connected to the gas recovery tube 94. The gas recovery port 104 has a concentric opening. The gas recovery port 104 may be coupled with a porous member, such as sponge, or may be a slit-shaped opening. A sintered fiber or granular (powder) metallic material and inorganic material are particularly suitable for the porous member. The porous member is preferably made of such a material (that forms at least a surface) as stainless steel, nickel, alumina, SiO₂, SiC, and SiC that has SiO₂ only on its surface through a thermal treatment. The gas recovery port 104 is formed, as shown in FIGS. 2 and 4, inside of the gas supply port 102. While this embodiment forms the gas recovery port 104 concentrically, it may be formed segmentally.

As discussed above, as the liquid LW moves with the high-speed movements of the wafer stage 45, the interface of the liquid LW moves back and forth between the gas recovery port 104 and the holder. Any step between the gas recovery port 104 and the holder would roll in the gas bubbles, causing the exposure error. Therefore, the gas recovery port 104 and the holder are preferably approximately level with each other.

A width W2 of the gas recovery port 104 is made greater than a width W1 of the gas supply port 102.

The convex 100a defines a length of the space between the final surface of the projection optical system 30 and the wafer 40 in the scanning (or x-axis) direction. When the liquid LW spreads to a position below the convex 100a with the movements of the wafer 40 plane in the immersion exposure, its flow speed increases at its both sides and the gas PG may not fully stop the spread of the liquid LW. For example, when a surface contacting the liquid LW has a small contact angle, the liquid LW moves and spreads too fast to stop. Accordingly, this embodiment provides the gas supply port 102 at the bottom of the convex 100a, and stops a flow shortage of the gas PG blown to the liquid LW, even when the liquid LW spreads to the position below the convex 100a. This configuration stops spread of the liquid LW.

The resolving power improves when the optical path space is filled with the liquid LW that is an organic or inorganic material having a refractive index higher than that of pure water. However, the material causes a vaporized material to contaminate inner and outer atmospheres of the exposure apparatus 1, possibly clouding or eroding an optical element in the exposure apparatus 1. In this embodiment, the convex 100a maintains the interface of the liquid LW, and prevents the evaporated liquid LW from spreading outside the convex 100a.

The exposure apparatus 1 arranges the liquid recovery port 103 outside the liquid supply port 101, and restrains the liquid LW from spreading to the outside. In addition, the width W2 of the gas recover port 104 broader than the width W1 of the gas supply port 102 reduces clogging of the liquid LW in the gas recovery port 104 when the gas recovery port 104 sucks the liquid LW. This configuration can prevent the supplied gas PG from spreading beyond the space between the final surface of the projection optical system 30 and the wafer 40 plane or from mixing in the liquid LW. Moreover, the convex 100a that defines the space between the projection optical system and the wafer 40 enables the flow velocity of the gas supplied from the bottom of the convex 100a to be controlled. As a result, the convex 100a stops dispersions of the liquid LW, maintains the exposure dose notwithstanding gas bubbles, and improves the throughput.

The convex 100a when coated with or made of a liquid repellent material would reduce leaks of the liquid LW from the convex 100a. This configuration even with a smaller amount of the gas PG can make dispersions of the liquid LW smaller than nonuse of the liquid repellent material. The liquid repellent material when using fluoro-resin, particularly PTFE, PFA, and silane containing perfluoro alkyl group would maintain a contact angle of 90° or greater on (the surface of) the convex 100a for the liquid LW of pure water.

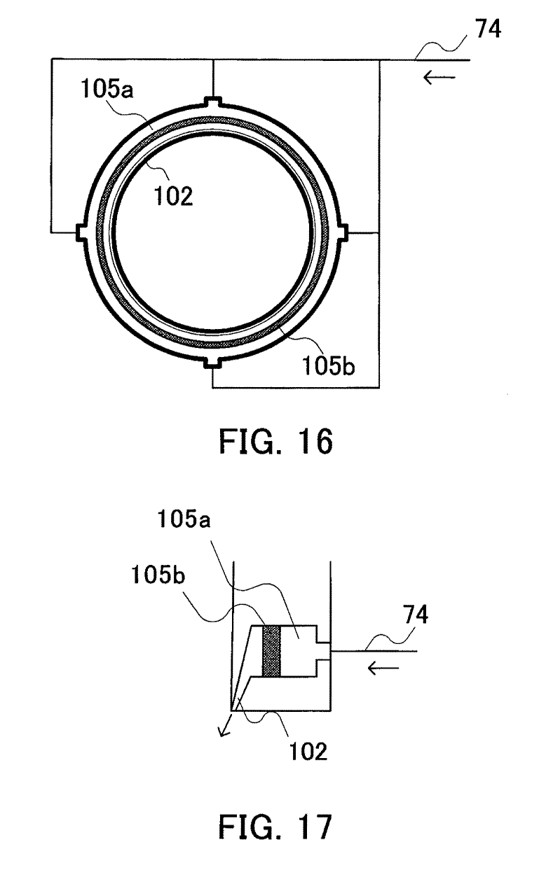

FIG. 16 is a sectional view of the convex 100a in a horizontal direction. FIG. 17 is a sectional view of the pipe shown in FIG. 16 in a direction perpendicular to the paper plane. A porous member 105b having a high pressure loss when arranged in a pressure uniformization chamber 105a enables more gases to be flowed, as shown in FIGS. 16 and 17.

Given a large gas supply amount without the porous member 105b in the pressure uniformization chamber 105a, the flow velocity of the supplied gas from the gas supply port 102 is hard to uniform, and is fast at a position close to pipe connection part. For the gas supply port 102, the porous member 105b, such as sponge, needs to have a high pressure loss for uniformity, but overemphasis of the uniformity would result in a pressure loss that is too high to obtain a necessary gas supply amount.

The configurations in FIGS. 16 and 17 can make a fast and uniform flow velocity distribution in supplying gas from the gas supply port 102. This structure can also increase flow, and obtain a uniform flow velocity distribution even in recovering gas, supplying and recovering the liquid LW.

### First Embodiment

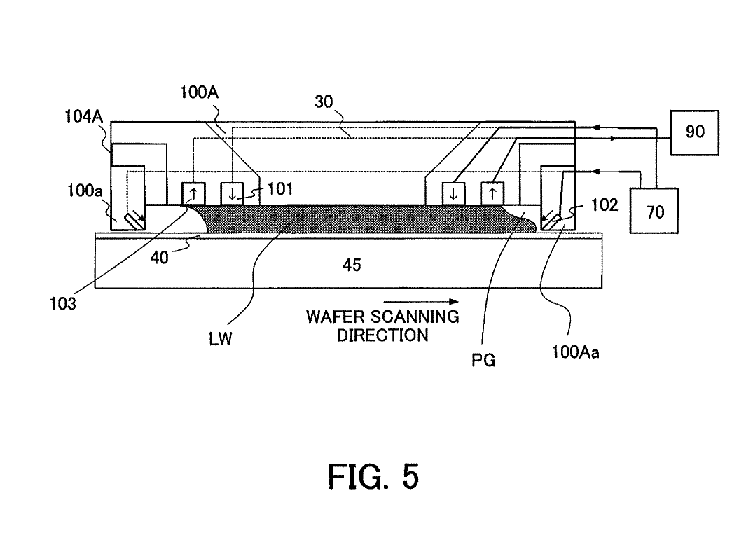

Referring now to FIG. 5, a description will be given of a lens barrel 100A as another embodiment of the lens barrel 100. Here, FIG. 5 is a schematic sectional view showing the lens barrel 100A as another embodiment of the lens barrel 100. The lens barrel 100A serves to hold the projection optical system 30, and includes, as shown in FIG. 5, the liquid supply port 101, the gas supply port 102, the liquid recovery port 103, a gas recovery port 104A, and the convex 100a. The lens barrel 100A is different from the lens barrel 100 shown in FIG. 2 in the gas recovery port 104A.

The gas recovery port 104A is an opening that recovers the supplied gas PG, and connected to the outside. The gas recovery port 104A has a concentric opening. The gas recovery port 104A may be coupled with a porous member, such as sponge, or may be a slit-shaped opening. The gas recovery port 104A is formed, as shown in FIG. 5, inside of the gas supply port 102. While this embodiment forms the gas recovery port 104A concentrically, it may be formed segmentally. The gas recovery port 104A is preferably wider than the gas supply port 102 so as to prevent clogging of the liquid LW in the gas recovery port 104A when it sucks the liquid LW.

The following ideal relationship exists among a liquid supply amount S101 from the liquid supply port 101, a recovery amount O103 (including both liquid and gas) form the liquid recovery port 103, a gas supply amount S102 from the gas supply amount 102, and a gas recovery amount O104 of the gas recovery port 104:

S101+S102=O103+O104

The liquid LW moves with the fast movements of the wafer stage 45, changes a distribution of the liquid LW near the liquid recovery port 101, and changes a gas recovery amount recovered by the liquid recovery port 103. The pressure fluctuations occur in the space of the convex 100a at the lens side (or at an optical axis OA side of the projection optical system 30) if the gas recovery port 104A recovers a constant amount of gas. Due to the gas flow in and out of via the bottom surface of the convex 100a, the liquid LW has an unstable interface and gas bubbles are likely to occur. Preferably, as in this embodiment, the gas recovery port 104A serves as a vent connected to the outside. Use of the gas recovery port 104A as a vent would reduce pressure fluctuations in the space at the lens side of the convex 100a and generations of gas bubbles.

An alternative embodiment connects a gas supply/recovery pipe (not shown) to the gas recovery port 104A, measure the pressure of the gas supply/recovery pipe, and controls supply and recovery of the gas so as to maintain the pressure. This configuration would reduce pressure fluctuations in the space of the convex 100a at the lens side, and generations of gas bubbles. A gas supply amount from the gas supply port 102 can be easily increased up to about several hundreds L/min by increasing the pressure of the gas supply source in the fluid supplier 70. However, when the gas recovery port 104A is connected to the gas supply/recovery pipe, the maximum gas recovery amount is restricted by the length and the internal diameter of the pipe and such a large recovery amount as several hundreds L/min is difficult to achieve. Preferably, the gas recovery port 104A is used as a vent when a larger gas supply amount is needed to facilitate spread of the liquid LW to the outside. Use of the gas recovery port 104A as the vent would reduce an increase of the pressure at the lens side of the convex 100a.

The lens barrel 100A arranges the liquid recovery port 103 outside the liquid supply port 101, and restrains the liquid from spreading to the outside. Thereby, the supplied gas PG is prevented from escaping from the space between the final surface of the projection optical system 30 and the wafer 40 plane, and from mixing in the liquid LW. The convex 100a that defines the space between the projection optical system 30 and the wafer 40 controls the flow velocity of the gas from the convex 100a. As a result, the convex 100a prevents dispersions of the liquid LW and decrease of an exposure dose due to the gas bubbles, and improves the throughput.

The convex 100a when coated with or made of a liquid repellent material reduces spread of the liquid LW beyond the convex 100a. This configuration even with a small supply amount of the gas PG can make dispersions of the liquid LW smaller than nonuse of the liquid repellent material. An outer-side wall surface of the liquid recovery port 103 when made similarly repellent would further reduce spread of the liquid. The liquid repellent material when using fluoro-resin, particularly PTFE, PFA, and silane containing perfluoro alkyl group would maintain a contact angle of 90° or greater on (the surface of) the convex 100a for the liquid LW of pure water.

Where the liquid recovery port 103 has insufficient recovery capacity of the liquid LW, an additional liquid recovery port (not shown) when arranged inside the liquid supply port 101 would complement the shortage of the recovery capacity of the liquid recovery port 103.

When the gas PG is dry gas that does not contain moisture or inert gas, the liquid LW is likely to evaporate, and the wafer 40 is cooled due to the influence of the evaporation heat. Then, the temperature of the wafer 40 decreases, the wafer 40 surface deforms, and the exposure precision deteriorates.

This embodiment includes the vapors in the gas PG supplied from the gas supply port 102, and the vapors have the same composition as the liquid LW or those of the evaporated liquid W. The gas supply port 102 thus supplies the gas PG that contain the vapors of the liquid LW, and restrains the evaporation of the liquid LW, maintaining the exposure precision notwithstanding the evaporation heat of the liquid LW. For such a liquid LW as a high refractive material, the vapors included in the gas PG supplied from the gas supply port 102 restrain the evaporation of the liquid LW. A humidifier (not shown) mixes the vapors in the gas PG. The humidifier mixes the vapors, for example, by generating the vapors in a predetermined area, and by passing the gas PG in the space in which the vapors are generated. The vapor mixture amount in the gas PG by the humidifier is a saturated vapor pressure at most, and adjustable.

When the gas supply port 102 supplies the gas PG, the internal pressure is higher than the external pressure of the gas supply port 102 due to the channel's pressure loss. In addition, the temperature drops due to the adiabatic expansion that occurs when the gas supply port 102 blows the gas PG. Therefore, in controlling the wafer 40 a predetermined temperature, a temperature of the gas PG from the gas supply port 102 is controlled slightly higher than the predetermined temperature.

When the vapor mixture amount in the gas PG inside the gas supply port 102 is set to the saturated vapor pressure, condensation occurs on the wafer 40 plane due to the pressure and temperature drops when the gas PG is blown to the gas supply port 102. The condensation causes the evaporation heat when the dew evaporates, similarly deteriorating the exposure precision. It is thus preferable to set the relative humidity in the gas supply port 102 such that the condensation does not occur outside the gas supply port 102.

For example, when the liquid LW uses pure water, the relative humidity of a clean room in which the exposure apparatus is placed is generally controlled to about 40%. Therefore, the relative humidity outside the gas supply port 102 is preferably set between 40% and 100%.

A gas recovery tube (not shown) is connected to the gas recovery port 104A and a sum of recovery amounts of the gas PG recovered from the gas recovery port 104A and the liquid recovery port 103 is set equal to or greater than a supply amount of the gas PG supplied from the gas supply port 102. Thereby, the vapor supplied with the gas PG is prevented from leaking to the outside of the convex 100a. A reduced vapor leaking amount to the outside of the convex 100a would prevent erosions of mechanical components in the exposure apparatus 1 without limiting the liquid LW to pure water (for example, even when a high refractive material that is likely to erode the metal is used for the liquid LW).

When the wafer 40 is replaced, for example, in a single-stage exposure apparatus, the liquid recovery port 103 recovers all the liquid LW from the space between the final surface of the projection optical system 30 and the wafer 40. When the liquid LW remains on the final surface or lens of the projection optical system 30, the evaporation of the remaining liquid LW causes the evaporation heat. As described above, the evaporation heat causes a deformation of the projection optical system 30. In addition, when the remaining liquid LW evaporates, the resist component dissolved in the liquid LW on the wafer 40 plane dries up, and adheres to the final lens, causing a deterioration of the exposure accuracy. Accordingly, even when the wafer 40 is replaced, the gas PG that contains vapor is supplied from the gas supply port 102. This configuration can prevent evaporation of the liquid LW that remains on the final lens of the projection optical system 30, as well as preventing cooling of the final lens. A twin-stage exposure apparatus recovers all the liquid LW from the space between the wafer 40 and the final surface of the projection optical system 30 in exchanging the stage. Even when there is no stage under the projection optical system 30, the gas supply port 102 may supply the vapor-containing gas PG. Of course, in order to maintain the liquid LW under the final lens of the projection optical system 30, or in order to prevent dispersions of the vapor around the projection optical system 30 in supplying the vapor-containing gas PG, two stages may be switched continuously. This exchange of the wafer would maintain the high humidity in the space under the final lens of the projection optical system 30, and prevent the evaporation of the liquid LW from the final lens.

### Second Embodiment

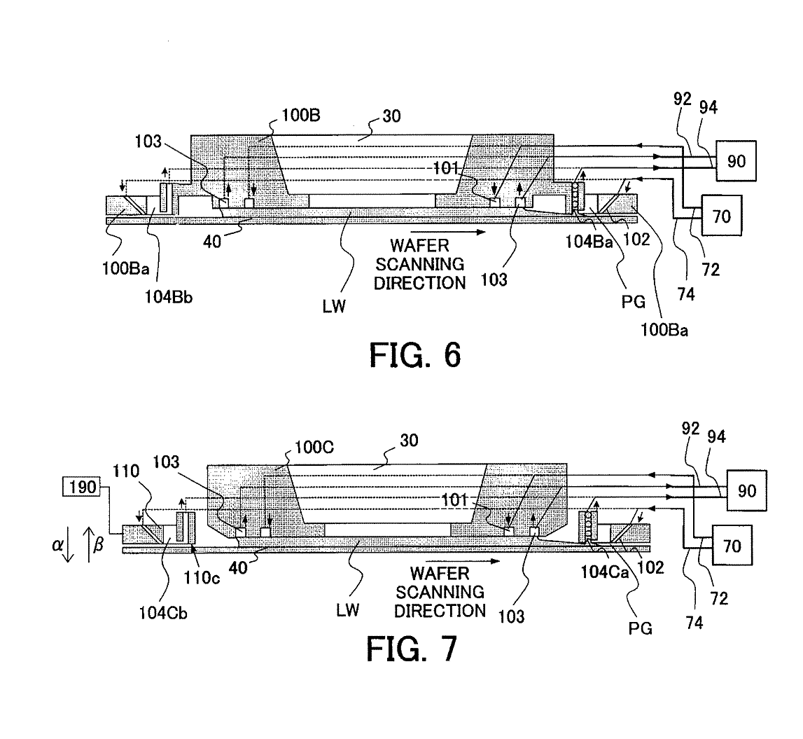

Referring now to FIG. 6, a description will be given of a lens barrel 100B as another embodiment of the lens barrel 100. Here, FIG. 6 is a schematic sectional view showing the lens barrel 100B as another embodiment of the lens barrel 100. The lens barrel 100B serves to hold the projection optical system 30, and includes, as shown in FIG. 6, the liquid supply port 101, the gas supply port 102, the liquid recovery port 103, gas recovery ports 104Ba and 104Bb, and a convex 100Ba. The lens barrel 100B is different from the lens barrel 100 shown in FIG. 2 in the gas recovery ports 104Ba and 104Bb and the convex 100Ba.

The convex 100Ba serves to prevent dispersions of the liquid LW in this embodiment, and has the gas supply port 102, the gas recovery ports 104Ba and 104Bb.

The gas recovery port 104Ba is an opening that sucks the surrounding atmosphere when the wafer stage 45 is stopped, and recovers the liquid film (or the liquid LW) leaking in the scan direction when the wafer stage 45 is moved. The gas recovery port 104Ba is connected to the gas recovery tube 94. The gas recovery port 104Ba has a concentric opening. The gas recovery port 104Ba may be coupled with a porous member, such as sponge, or may be a slit-shaped opening. The gas recovery port 104Ba is formed, as shown in FIG. 6, inside of the gas supply port 102. While this embodiment forms the gas recovery port 104Ba concentrically, it may be formed segmentally.

The gas recovery port 104Bb is an opening that recovers the supplied gas PG, and connected to the outside. The gas recovery port 104Bb recovers the evaporated liquid LW with the supplied gas PG when connected to a gas recovery tube (not shown). The gas recovery port 104Bb has a concentric opening. The gas recovery port 104Bb may be coupled with a porous member, such as sponge, or may be a slit-shaped opening. The gas recovery port 104Bb is formed, as shown in FIG. 6, inside of the gas supply port 102. While this embodiment forms the gas recovery port 104Bb concentrically, it may be formed segmentally.

In general, as the gas recovery port 104Ba starts absorbing or recovering the liquid LW, the flow velocity of the liquid LW at the gas recovery port 104Ba becomes much lower than that of the gas recovery port 104Ba that absorbs no gas PG. The liquid LW that cannot be absorbed would otherwise leak to the outside. This embodiment blows the gas PG from the gas supply port 102 provided outside the gas recovery port 104Ba and restrains spread of the liquid LW (liquid film). The gas recovery port 104Bb is located between the gas recovery port 104Ba and the gas supply port 102, has a section area that does not absorb the liquid LW, and forms a channel for the gas PG. Without the gas recovery port 104Bb, as discussed above, when the gas recovery port 104Ba absorbs the liquid LW, the flow velocity of the liquid LW remarkably decreases, and most of the gas PG supplied from the gas recovery port 104Ba spreads to the outside. As a result, it is impossible to restrain spread of the leaking liquid LW (liquid film) due to movements of the wafer stage 45.

In restraining spread of the liquid LW (liquid film) by blowing the gas PG from the gas supply port 102, the liquid LW (liquid film) disturbs and gas bubbles can occur. In this case, the generated gas bubbles are recovered with the spread-restrained liquid LW (liquid film) at the gas recovery port 104Ba. The lens barrel 100B arranges the liquid recovery port 103 outside the liquid supply port 101. This configuration is effective even when a moving direction of the wafer stage 45 inverts and the gas recovery port 104Ba cannot fully recover the gas bubbles generated by the above reason, because this configuration prevents the gas bubbles generated outside the liquid supply port 101 from entering the inside of the liquid supply port 101, and restrains the liquid less likely from spreading to the outside.

A distance between a wall surface 104Ba1 of the gas recovery port 104Ba and the wafer 40 surface is made smaller than a distance between a wall surface 104Ba2 of the gas recovery port 104Ba and the wafer 40 surface. The wall surface 104Ba1 is arranged closer to the projection optical system 30 than the wall surface 104Ba2, and this arrangement restrains the liquid LW from spreading to the outside of the gas recovery port 104Ba by the dynamic pressure of the gas supplied from the gas supply port 102, and facilitates a recovery of the liquid LW that spreads with the supplied gas. When the distance between the gas recovery port 104Ba and the wafer 40 is equal to or smaller than several hundreds μm, a difference between the distance between the wall surface 104Ba1 and the wafer 40 and the distance between the 104Ba2 and the wafer 40 would prevent an adherence of the gas recovery port 104Ba onto the wafer 40 plane.

Similar to the first embodiment, the convex 100Ba when coated with or made of a liquid repellent material would reduce spread of the liquid LW beyond the convex 100Ba. The liquid repellent material when using fluoro-resin, particularly PTFE, PFA, and silane containing perfluoro alkyl group would maintain a contact angle of 90° or greater on (the surface of) the convex 100a for the liquid LW of pure water. Since the gas recovery port 104Ba needs to aggressively absorb the spreading liquid LW, the gas recover port 104Ba and the wall surface 104Ba2 are preferably coated with or made of a hydrophilic material. When the hydrophilic material uses SiO₂, SiC, stainless steel, a contact angle between the gas recovery port 104Ba and the wall surface 104Ba2 can be made smaller than 90° for the liquid LW of pure water. This configuration minimizes spread of the liquid LW (liquid film) during operations of the wafer stage 45, prevents dispersions of the liquid LW, and decrease of an exposure dose due to the gas bubbles, and improves the throughput.

When the gas recovery port 104Ba absorbs the liquid LW and the gas PG simultaneously, significant vibrations occur. In the step-and-scan exposure, spread of the liquid film LW is small during one-shot exposure that has a small moving distance. Therefore, in order to prevent vibrations from transmitting to the projection optical system 30, recovery from the gas recovery port 104Ba and supply of the gas PG from the gas supply port 102 are stopped. On the other hand, in the step movement having a long moving distance, recovery from the gas recovery port 104Ba and supply of the gas PG from the gas supply port 102 are resumed. Thereby, it is possible to prevent transmissions of the vibrations to the projection optical system 30 during exposure in absorbing the liquid LW and the gas PG simultaneously.

When the liquid recovery port 103 has insufficient recovery capacity of the liquid LW, an additional liquid recovery port (not shown) when arranged inside the liquid supply port 101 would complement the shortage of the recovery capacity of the liquid recovery port 103.

Similar to the first embodiment, a humidifier (not shown) mixes the vapors in the gas PG, and the gas supply port 102 supplies the vapor-containing gas PG. This configuration restrains the evaporation of the liquid LW, and prevents a deterioration of the exposure precision due to the evaporation heat of the liquid LW.

When a sum of recovery amounts of the gas PG recovered from the gas recovery ports 104Ba and 104Bb is set equal to or greater than a supply amount of the gas PG supplied from the gas supply port 102, the vapors supplied with the gas PG are prevented from leaking to the outside of the convex 100Ba.

The second embodiment encloses the lens barrel 100B with the convex 100Ba. A recovery amount (of the liquid and the gas) from the liquid recovery port 103 is set more than a liquid supply amount from the liquid supply port 101. Therefore, the space of the convex 100Ba at the lens side is in negative pressure, and the bottom surface of the convex 100Ba absorbs lots of gas. When the distance between the bottom surface of the convex 100Ba and the wafer 40 is such a small distance as several hundreds μm, the flow velocity of the absorbed gas is as fast as several m/sec or greater and the interface of the liquid LW becomes unstable and bubbles are likely to occur.

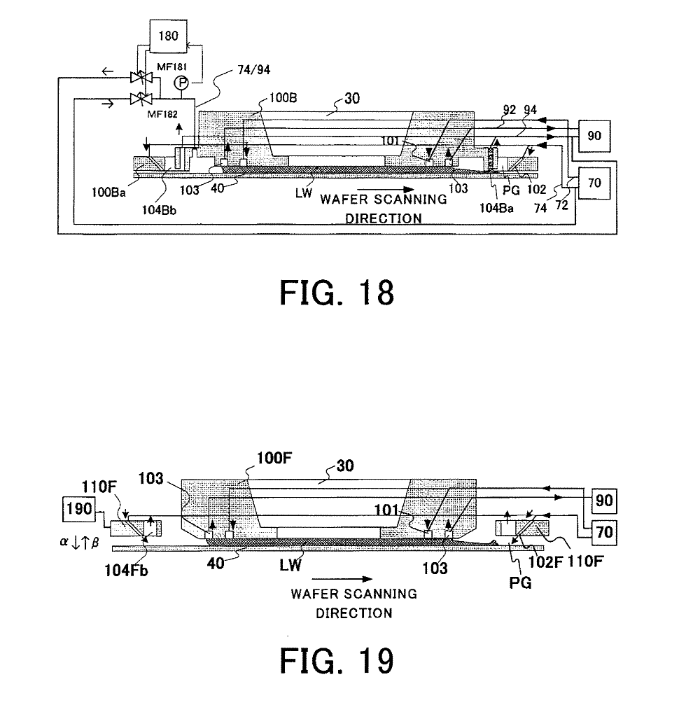

FIG. 18 connects a flow controller MF 181 to the gas recovery tube 94 and a flow controller MF 182 to the gas supply tube 74, thereby controlling supply and recovery of gas to the gas supply/recovery pipes 74/94. The gas supply/recovery pipes 74/94 are connected between the convex 100Ba and the liquid recovery port 103, and the controller 180 controls the flow controllers MF 181 and MF 182 so that the pressure in the gas supply/recovery pipes 74/94 accords with the measurement result by the pressure measuring means P. This configuration enables the controller 180 to restrain the space of the convex 100Ba at the lens side from being in negative pressure. The controller 180 may be integrated with the flow controllers of the fluid supplier 70 and fluid recoverer 90. Similar to the first embodiment, the vent may be provided instead of connecting the gas supply/recovery pipes 74/94 between the convex 100Ba and the liquid recovery port 103.

In exchanging the wafer 40, similar to the first embodiment, the gas supply port 102 supplies the vapor-containing gas PG, preventing the evaporation of the liquid LW that remains on the final lens of the projection optical system 30. The twin-stage exposure apparatus may switch two stages continuously, and maintain the liquid LW under the final lens of the projection optical system 30.

### Third Embodiment

Referring now to FIG. 7, a description will be given of a lens barrel 100C as another embodiment of the lens barrel 100. Here, FIG. 7 is a schematic sectional view showing the lens barrel 100C as another embodiment of the lens barrel 100. The lens barrel 100C serves to hold the projection optical system 30, and includes, as shown in FIG. 7, the liquid supply port 101, the gas supply port 102, the liquid recovery port 103, gas recovery ports 104Ca and 104Cb, and a convex 110c. The lens barrel 100C is different from the lens barrel 100 shown in FIG. 2 in the gas recovery ports 104Ca and 104Cb and the convex 110c.

The convex 110c of this embodiment serves to prevent dispersions of the liquid LW. The convex 110c is provided as a separate member from the lens barrel 100C, and has the gas supply port 102 and the gas recovery ports 104Ca and 104Cb.

The gas recovery port 104Ca is an opening that sucks the surrounding atmosphere when the wafer stage 45 is stopped, and recovers the liquid film (or the liquid LW) leaking in the scan direction when the wafer stage 45 is moved. The gas recovery port 104Ca is connected to the gas recovery tube 94. The gas recovery port 104Ca has a concentric opening. The gas recovery port 104Ca may be coupled with a porous member, such as sponge, or may be a slit-shaped opening. The gas recovery port 104Ca is formed, as shown in FIG. 7, inside of the gas supply port 102. While this embodiment forms the gas recovery port 104Ca concentrically, it may be formed segmentally.

The gas recovery port 104Cb is an opening that recovers the supplied gas PG, and connected to the outside. The gas recovery port 104Cb recovers the evaporated liquid LW with the supplied gas PG when connected to a gas recovery tube (not shown). The gas recovery port 104Cb has a concentric opening. The gas recovery port 104Cb may be coupled with a porous member, such as sponge, or may be a slit-shaped opening. The gas recovery port 104Cb is formed, as shown in FIG. 7, inside of the gas supply port 102. While this embodiment forms the gas recovery port 104Cb concentrically, it may be formed segmentally.

Similar to the second embodiment, as the gas recovery port 104Ca starts absorbing or recovering the liquid LW, the flow velocity of the liquid LW at the gas recovery port 104Ca becomes much lower than that of the gas recovery port 104Ca that absorbs no gas PG. The liquid LW that cannot be absorbed would otherwise leak to the outside. The third embodiment blows the gas PG from the gas supply port 102 provided outside the gas recovery port 104Ca and restrains spread of the liquid LW (liquid film). The gas recovery port 104Cb is located between the gas recovery port 104Ca and the gas supply port 102, has a section area that does not absorb the liquid LW, and forms a channel for the gas PG. Without the gas recovery port 104Cb, as discussed above, when the gas recovery port 104Ca absorbs the liquid LW, the flow velocity of the liquid LW remarkably decreases, and most of the gas PG supplied from the gas recovery port 104Ca spreads to the outside. As a result, it is impossible to restrain spread of the leaking liquid LW (liquid film) due to the movement of the wafer stage 45.

In restraining spread of the liquid LW (liquid film) by blowing the gas PG from the gas supply port 102, the liquid LW (liquid film) disturbs and gas bubbles can occur. In this case, the generated gas bubbles are recovered with the spread-restrained liquid LW (liquid film) at the gas recovery port 104Ca. In addition, as discussed above, even when a moving direction of the wafer stage 45 inverts and the gas recovery port 104Ca cannot fully recover the gas bubbles, this configuration prevents the gas bubbles from entering the inside of the liquid supply port 101, and restrains the liquid becomes from spreading to the outside.

Similar to the first embodiment, the convex 110c when coated with or made of a liquid repellent material would reduce spread of the liquid LW beyond the convex 110c. Since the gas recovery port 104Ca needs to aggressively absorb the spreading liquid LW, a hydrophilic material is preferably applied to the gas recover port 104Ca and its vicinity.

This configuration minimizes spread of the liquid LW (liquid film) during operations of the wafer stage 45, prevents dispersions of the liquid LW and decrease of an exposure dose due to the gas bubbles, and improves the throughput.

When the gas recovery port 104Ca absorbs the liquid LW and the gas PG simultaneously, significant vibrations occur. The third embodiment separates the lens barrel 100C from the gas recovery port 104Ca, as shown in FIG. 7, to prevent transmissions of the vibrations to the projection optical system 30. Separate supporting of the gas recovery port 104Ca and projection optical system 30 prevents transmissions of the vibrations to the projection optical system 30 in absorbing the liquid LW and gas PG simultaneously. For further reductions of the vibrations, similar to the second embodiment, it is preferable to stop absorbing from the gas recovery port 104Ca and supplying the gas PG from the gas supply port 102 during exposure.

When the supply and recovery of the gas PG stop in order to restrain the vibrations of the convex 110c during exposure, the liquid LW spreads along with the movement of the stage if a contact angle of the resist applied to the wafer 40 plane is small. Therefore, when a distance between the convex 110c and the wafer 40 is so small as 0.5 mm or smaller, the liquid LW gets in a space between the convex 110c and the wafer 40 and the liquid LW contacts the convex 110c. This contact deforms the liquid LW, and fluctuates the pressure applied on the wafer 40 plane greater than several hundreds Pa, affects the control performance of the stage, and possibly deteriorates the exposure accuracy. The third embodiment has an adjustment mechanism 190 that adjusts a distance between the convex 110c and the wafer 40. The adjustment mechanism 190 adjusts a distance between the convex 110c and the wafer 40 so that the spreading liquid LW does not contact the convex 110c in stopping supply and recovery of the gas PG. In other words, the adjustment mechanism 190 serves to adjust distances between each of the gas recovery ports 104Ca and 104Cb and the wafer 40. The adjustment mechanism 190 adjusts the convex 110c in a direction (of arrow) shortening distances between each of the gas recovery ports 104Ca and 104Cb and the wafer 40 when the gas recovery ports 104Ca and 104Cb recover the gas PG. The adjustment mechanism 190 adjusts the convex 110c in a direction (of arrow prolonging the distances between each of the gas recovery ports 104Ca and 104Cb and the wafer 40 except when the gas recovery ports 104Ca and 104Cb recover the gas PG. This configuration prevents contact between the liquid LW and the convex 110c, and maintains the exposure accuracy.

Similar to the first embodiment, a humidifier (not shown) mixes the vapors in the gas PG, and the gas supply port 102 supplies the vapor-containing gas PG. This configuration restrains evaporation of the liquid LW, and prevents a deterioration of the exposure precision due to the evaporation heat of the liquid LW.

The liquid recovery port 103 actually recovers more gases than the supplied gases from the liquid supply port 101. Even when the space between the convex 110c and projection optical system 30 is used as a vent, the leaks of the vapors to the outside can be prevented.

The third embodiment forms the convex 110c and the projection optical system 30 as separate units. An alternate embodiment connects the convex 110c and the projection optical system 30 to each other by soft resin or flexible metal that are hard to transmit vibrations, and prevents leaks of the vapors from the liquid LW.

Since, as discussed above, the liquid recovery port 103 recovers more gases than the supplied gases from the liquid supply port 101, the convex 110c at the lens side is in negative pressure and the bottom surface of the convex 110c absorbs lots of gas. When a distance between the bottom surface of the convex 100c and the wafer 40 is such a small distance as several hundreds μm, the flow velocity of the absorbed gas is as fast as several m/sec or greater, so that the liquid LW has an unstable interface and bubbles are likely to occur. Therefore, a gas supply/recovery pipe (not shown) is connected to a member that seals an aperture between the convex 110c and the projection optical system 30, the pressure of the gas supply/recovery pipe is measured, and the supply and recovery of the gas are controlled so that the pressure can be maintained. This configuration prevents the pressure of the convex 110c at the lens side from being negative.

When a sum of recovery amounts of the gas PG recovered from the gas recovery ports 104Ca and 104Cb is set equal to or greater than a supply amount of the gas PG supplied from the gas supply port 102, the vapors supplied with the gas PG are prevented from leaking to the outside of the convex 100c.

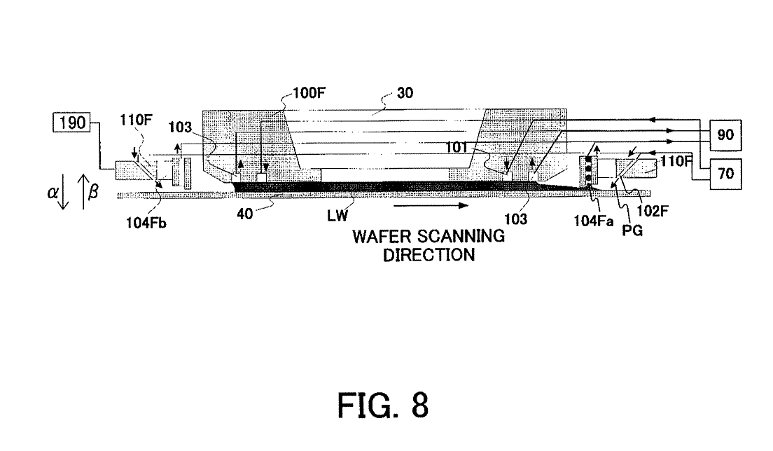

As shown in FIG. 7, the gas supply port 102 of this embodiment is lower than the final lens of the projection optical system 30 when viewed from the wafer 40. Alternatively, as shown in FIG. 8, a gas supply port 102F may be higher than the final lens of the projection optical system 30 when viewed from the wafer 40. When a distance between the convex 110F and the wafer 40 is made small, the interference between them can be restrained even when the wafer stage 45 pitches. In other words, a low position of the wall surface of the convex 110F at the lens barrel 110F, which has the gas recovery port 104Fa, can restrain disturbance of the liquid LW due to the gas PG supplied from the gas supply port 102F. This configuration, similar to FIG. 7, can restrain the leakage of the liquid LW due to the scanning of the wafer stage 45.

Similar to the first embodiment, the convex 110F when coated with or made of a liquid repellent material would reduce dispersions of the liquid LW from the convex 110F. The liquid repellent material when using fluoro-resin, particularly PTFE, PFA, and silane containing perfluoro alkyl group would maintain a contact angle of 90° or greater on (the surface of) the convex 110F for the liquid LW of pure water. Since the gas recovery port 104Fa needs to aggressively absorb the spreading liquid LW, the gas recover port 104Fa and its vicinity are preferably coated with or made of a hydrophilic material.

As discussed above, it is preferable that the adjustment mechanism 190 that adjusts a distance between the convex 110F and the wafer 40 lengthens a distance between them, in stopping the supply and recovery of the gas PG, so that the spreading liquid LW does not contact the convex 110F.

The humidifier (not shown) mixes the vapors in the gas PG, and the gas supply port 102 supplies the vapor-containing gas PG. This configuration can restrain the evaporation of the liquid LW, and prevent a deterioration of the exposure precision due to the evaporation heat of the liquid LW.

The liquid recovery port 103 recovers more gases than the supplied gases from the liquid supply port 101. Even when the space between the convex 110F and projection optical system 30 is used as a vent, the leaks of the vapors to the outside can be prevented.

This embodiment forms the convex 110F and the projection optical system 30 as separate units. An alternate embodiment connects the convex 110F and the projection optical system 30 to each other by soft resin or flexible metal that are hard to transmit vibrations, and prevents leaks of the vapors from the liquid LW.

Since, as discussed above, the liquid recovery port 103 recovers more gases than the supplied gases from the liquid supply port 101, the convex 110F at the lens side is in negative pressure and the bottom surface of the convex 110F absorbs lots of gas. When a distance between the bottom surface of the convex 110F and the wafer 40 is such a small distance as several hundreds μm, the flow velocity of the absorbed gas is as fast as several m/sec or greater, so that the liquid LW has an unstable interface and bubbles are likely to occur. Therefore, a gas supply/recovery pipe (not shown) is connected to a member that seals an aperture between the convex 110F and the projection optical system 30, the pressure of the gas supply/recovery pipe is measured, and the supply and recovery of the gas are controlled so that the pressure can be maintained. This configuration prevents the pressure of the convex 110F at the lens side from being negative.

In exchanging the wafer 40, similar to the first embodiment, the gas supply port 102 supplies the vapor-containing gas PG, preventing the evaporation of the liquid LW that remains on the final lens of the projection optical system 30. The twin-stage exposure apparatus may switch two stages continuously, and maintain the liquid LW under the final lens of the projection optical system 30.

FIG. 8 sets an angle to about 45° between a supply direction of the gas PG from the gas supply port 102F and the wafer 45 plane. A similar effect is available by making this angle close to a direction perpendicular to the wafer 40 plane, even when a wall surface of the convex 110F at the lens barrel 100F side, which has the gas recovery port 104Fa, is set higher.

When the wafer 40 or level plate 44 has a high contact angle, the following two methods can restrain spread of the liquid LW.

A first method provides, as shown in FIG. 19, a gas supply port 102F and a gas recovery port 104Fb approximately level with or higher than the final lens when viewed from the wafer 40, eliminating the gas recovery port 104Fa. This configuration can restrain spread of the liquid LW when the wafer stage 45 moves. Similar to the first embodiment, the convex 110F when coated with or made of a liquid repellent material would reduce spread of the liquid LW beyond the convex 110F. The liquid repellent material when using fluoro-resin, particularly PTFE, PFA, and silane containing perfluoro alkyl group would maintain a contact angle of 90° or greater on (the surface of) the convex 110F for the liquid LW of pure water.

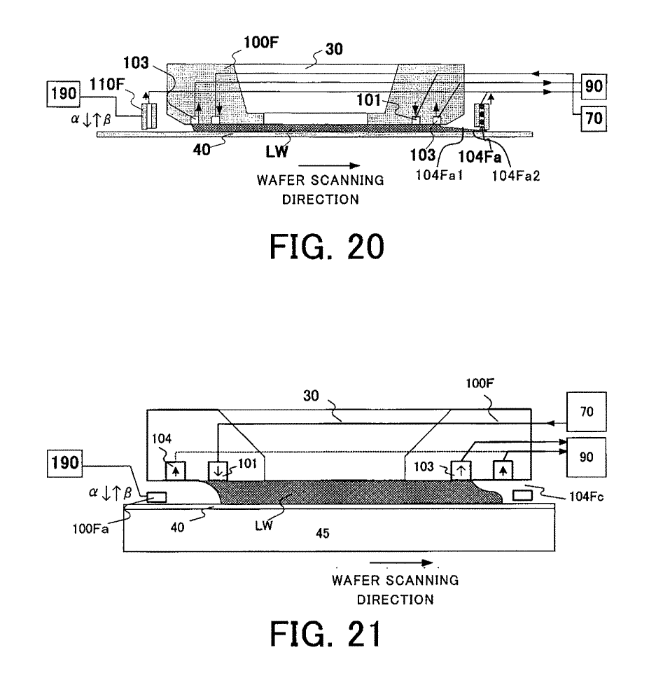

A second method uses only the gas recovery port 104Fa, as shown in FIG. 20, by removing the gas supply port 102F and 104Fb from the convex 110F. When the contact angle of the wafer 40 or level plate 44 is high, a spreading distance of liquid LW is small, and the liquid LW (liquid film) is thick when the liquid LW starts spread. Only the gas recovery port 104Fa at a low position thus can absorb the spreading liquid LW (liquid film), preventing spread of the liquid LW when the wafer stage 45 moves.

A distance between the wall surface 104Fa1 of the gas recovery port 104Fa and the wafer 40 plane is made longer than a distance between the wall surface 104Fa2 and the wafer 40 plane. The wall surface 104Fa1 is arranged closer to the projection optical system 30 than the wall surface 104Fa2, facilitating recovery of the spreading liquid LW and preventing the gas recovery port 104Fa from contacting the wafer 40 surface.

Similar to the first embodiment, the convex 110F when coated with or made of a liquid repellent material would reduce dispersions of the liquid LW from the convex 110F. Since the gas recovery port 104Fa needs to aggressively absorb the spreading liquid LW, the gas recover port 104Fa and the wall surface 104Fa1 are preferably coated with or made of a hydrophilic material.

The liquid repellent material when using fluoro-resin, particularly PTFE, PFA, and silane containing perfluoro alkyl group would maintain a contact angle of 90° or greater for the liquid LW of pure water.

The hydrophilic material when using SiO₂, SiC, stainless steel would maintain a contact angle smaller than 90° for the liquid LW of pure water.

Preferably, a porous member, such as a porous plate having fine holes, is provided between the wall surfaces 104Fa1 and 104Fa2 in the gas recovery port 104Fa. A sintered fiber or granular (powder) metallic material and inorganic material are particularly suitable for the porous member. The porous member is preferably made of such a material (that forms at least a surface) as stainless steel, nickel, alumina, SiO₂, SiC, and SiC that has SiO₂ only on its surface through a thermal treatment. These materials are suitable for pure water and fluoro-solution used for the liquid LW. An arrangement of the porous member at the gas recovery port 104Fa can reduce an uneven recovery amount by location. The liquid LW can be slowly sucked from the space between the gas recovery port 104Fa and the wafer 40, even when a pipe has such a large pressure loss to an exhaust system (not shown) that a sufficient exhaust amount cannot be obtained.

When the liquid LW is recovered at a higher position when viewed from the wafer 40, recovery at a high flow velocity would result in possible tear of the liquid LW. Therefore, slow recovery is necessary. Since the liquid LW is likely to be torn when recovered at a low position originally, it is necessary to recover, at a high flow velocity, the thin, leaking liquid LW with gas. Therefore, an average flow speed of the gas recovery port 104Fa should be made higher than an average flow speed of the liquid recovery port 103. Thereby, the liquid film becomes less likely to be torn and spread.

### Fourth Embodiment

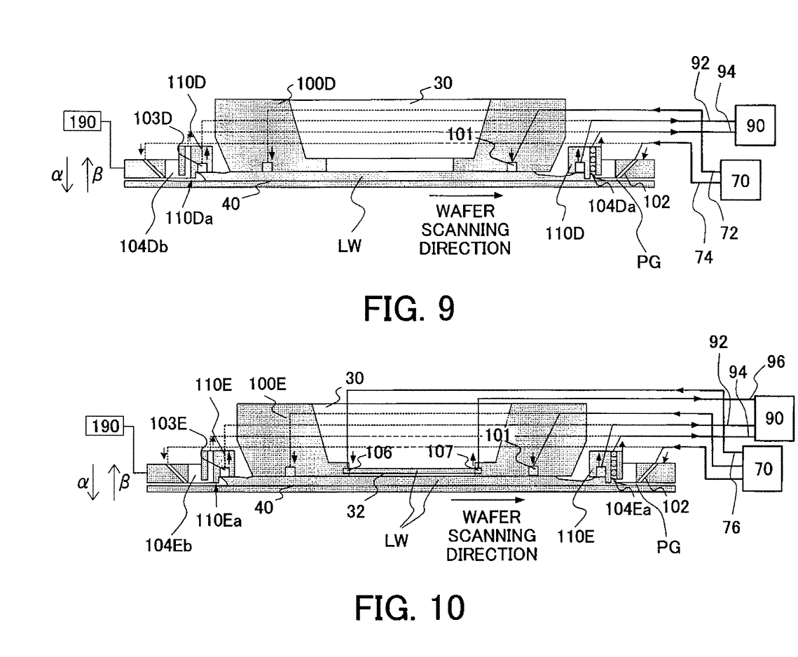

Referring now to FIG. 9, a description will be given of a lens barrel 100D as another embodiment of the lens barrel 100. Here, FIG. 9 is a schematic sectional view showing the lens barrel 100D as another embodiment of the lens barrel 100. The lens barrel 100D serves to hold the projection optical system 30, and includes, as shown in FIG. 9, the liquid supply port 101, the gas supply port 102, a liquid recovery port 103D, gas recovery ports 104Da and 104Db, and a convex 110D. The lens barrel 100D is different from the lens barrel 100 shown in FIG. 2 in the liquid recovery port 103D, the gas recovery ports 104Da and 104Db, and the convex 110D.

The convex 110D of the fourth embodiment serves to prevent dispersions of the liquid LW. The convex 110D is provided as a separate member from the lens barrel 100D, and has the gas supply port 102, the liquid recovery port 103D, and the gas recovery ports 104Da and 104Db.

The liquid recovery port 103D is an opening that recovers the supplied liquid LW, and connected to the liquid recovery tube 92. The liquid recovery port 103D has a concentric opening. The liquid recovery port 103D may be coupled with a porous member, such as sponge, or may be a slit-shaped opening. The liquid recovery port 103D is formed, as shown in FIG. 9, outside the liquid supply port 101. Since the liquid recovery port 103D is located outside the liquid supply port 101, the liquid LW becomes less likely to leak to the outside of the projection optical system 30. While this embodiment forms the liquid recovery port 103D concentrically, it may be formed segmentally.

Since the fourth embodiment forms the liquid recovery port 103D and the lens barrel 100D as separate units, the vibrations that occur when the gas PG is absorbed is less likely to transmit to the projection optical system 30.

The gas recovery port 104Da is an opening that sucks the surrounding atmosphere when the wafer stage 45 is stopped, and recovers the liquid film (or the liquid LW) leaking in the scan direction when the wafer stage 45 is moved. The gas recovery port 104Da is connected to the gas recovery tube 94. The gas recovery port 104Da has a concentric opening. The gas recovery port 104Da may be coupled with a porous member, such as sponge, or may be a slit-shaped opening. The gas recovery port 104Da is formed, as shown in FIG. 9, inside of the gas supply port 102. While this embodiment forms the gas recovery port 104Da concentrically, it may be formed segmentally.

The gas recovery port 104Db is an opening that recovers the supplied gas PG, and connected to the outside. The gas recovery port 104Db recovers the evaporated liquid LW with the supplied gas PG when connected to a gas recovery tube (not shown). The gas recovery port 104Db has a concentric opening. The gas recovery port 104Db may be coupled with a porous member, such as sponge, or may be a slit-shaped opening. The gas recovery port 104Db is formed, as shown in FIG. 9, inside of the gas supply port 102. While this embodiment forms the gas recovery port 104Db concentrically, it may be formed segmentally.

Similar to the second embodiment, as the gas recovery port 104Da starts absorbing or recovering the liquid LW, the flow velocity of the liquid LW at the gas recovery port 104Da becomes much lower than that of the gas recovery port 104Da that absorbs no gas PG. The liquid LW that cannot be absorbed would otherwise leak to the outside. This embodiment blows the gas PG from the gas supply port 102 provided outside the gas recovery port 104Da and restrains spread of the liquid LW (liquid film). The gas recovery port 104Db is located between the gas recovery port 104Da and the gas supply port 102, has a section area that does not absorb the liquid LW, and forms a channel for the gas PG. Without the gas recovery port 104Db, as discussed above, when the gas recovery port 104Da absorbs the liquid LW, the flow velocity of the liquid LW remarkably decreases, and most of the gas PG supplied from the gas recovery port 104Da spreads to the outside. As a result, it is impossible to restrain spread of the leaking liquid LW (liquid film) due to the movement of the wafer stage 45.

In restraining spread of the liquid LW (liquid film) by blowing the gas PG from the gas supply port 102, the liquid LW (liquid film) disturbs and gas bubbles can occur. In this case, the generated gas bubbles are recovered with the spread-restrained liquid LW (liquid film) at the gas recovery port 104Da. In addition, as discussed above, even when a moving direction of the wafer stage 45 inverts and the gas recovery port 104Da cannot fully recover the gas bubbles, this configuration prevents the gas bubbles from entering the inside of the liquid supply port 101, and restrains the liquid becomes from spreading to the outside.

Similar to the first embodiment, the convex 110D when coated with or made of a liquid repellent material would reduce spread of the liquid LW beyond the convex 110D. Since the gas recovery port 104Da needs to aggressively absorb the spreading liquid LW, a hydrophilic material is preferably applied to the gas recover port 104Da and its vicinity. Preferably, a component inside the gas recovery port 104Db uses a hydrophilic material, and a component outside the gas recovery port 104Db uses a liquid repellent material.

The liquid repellent material when using fluoro-resin, particularly PTFE, PFA, and silane containing perfluoro alkyl group would maintain a contact angle of 90° or greater for the liquid LW of pure water.

When the hydrophilic material uses SiO₂, SiC, stainless steel, a contact angle can be made smaller than 90° for the liquid LW of pure water.

This configuration minimizes spread of the liquid LW (liquid film) during operations of the wafer stage 45, prevents dispersions of the liquid LW, and decrease of an exposure dose due to the gas bubbles, and improves the throughput.

When the gas recovery port 104Da absorbs the liquid LW and the gas PG simultaneously, significant vibrations occur. This embodiment separates the lens barrel 100D from the liquid recovery port 101D, the gas recovery port 104Da, as shown in FIG. 9, so as not to transmit the vibrations to the projection optical system 30. Separate supporting of the liquid recovery port 101D and the gas recovery port 104Da from the projection optical system 30 prevents transmissions of the vibrations to the projection optical system 30 in absorbing the liquid LW and gas PG simultaneously.

For further reductions of the vibrations, similar to the second embodiment, it is preferable to stop absorbing from the gas recovery port 104Ca and supplying the gas PG from the gas supply port 102 during exposure.

When a contact angle is high on the wafer 40 surface, the liquid LW spreads short when the wafer stage 45 moves, and the leakage of the liquid LW (liquid film) can be restrained without the gas supply port 102, and the gas recovery ports 104Da and 104Db shown in FIG. 9. A configuration prevents the vibrations from transmitting to the projection optical system 30 in recovering the gas PG and the liquid LW simultaneously, by enhancing the recovery capacity of the liquid recovery port 103D, and by arranging only the liquid recovery port 103D at the lens barrel 100D.

Similar to the first embodiment, a humidifier (not shown) mixes the vapors in the gas PG, and the gas supply port 102 supplies the vapor-containing gas PG. This configuration restrains evaporation of the liquid LW, and prevents a deterioration of the exposure precision due to the evaporation heat of the liquid LW. The liquid recovery port 103 recovers more gases than the supplied gases from the liquid supply port 101. Even when the space between the convex 110c and projection optical system 30 is used as a vent, the leaks of the vapors to the outside can be prevented.

This embodiment forms the convex 110D and the projection optical system 30 as separate units. An alternate embodiment connects the convex 110D and the projection optical system 30 to each other by soft resin or flexible metal that are hard to transmit vibrations, and prevents leaks of the vapors from the liquid LW. In this case, since the liquid recovery port 103D recovers more gases than the supply amount of the liquid LW from the liquid supply port 101, the pressure becomes negative near the liquid recovery port 103D.

When the aperture between the convex 110D and the projection optical system 30 is not closed, the liquid recovery port 103D recovers the gas through the aperture, and the bottom of the convex 110D absorbs the gas. The gas bubbles are likely to occur by absorbing the gas between the convex 110D and the projection optical system 30.

When the aperture between the convex 110D and the projection optical system 30 is closed, the bottom surface of the convex 110D absorbs lots of gas. When a distance between the bottom surface of the convex 100D and the wafer 40 is such a small distance as several hundreds μm, the flow velocity of the absorbed gas is as fast as several m/sec or greater, so that the liquid LW has an unstable interface and bubbles are likely to occur. Therefore, a gas supply/recovery pipe (not shown) is connected to a member that seals an aperture between the convex 110D and the projection optical system 30, the pressure of the gas supply/recovery pipe is measured, and the supply and recovery of the gas are controlled so that the pressure can be maintained. This configuration prevents the pressure of the convex 110D at the lens side from being negative.

This configuration, however, causes the gas bubbles to occur in the liquid LW as a result of absorbing the gas from the aperture between the convex 110D and the projection optical system 30. The liquid recovery port 103D can recover the generated gas bubbles and prevents the gas bubbles from moving to the exposure area by increasing the supplied liquid amount from the liquid supply port 101.

In exchanging the wafer 40, similar to the first embodiment, the gas supply port 102 supplies the vapor-containing gas PG, preventing evaporation of the liquid LW that remains on the final lens of the projection optical system 30. The twin-stage exposure apparatus may switch two stages continuously, and maintain the liquid LW under the final lens of the projection optical system 30.

### Fifth Embodiment

Referring now to FIG. 10, a description will be given of a lens barrel 100E as another embodiment of the lens barrel 100. Here, FIG. 10 is a schematic sectional view showing the lens barrel 100E as another embodiment of the lens barrel 100. The lens barrel 100E serves to hold the projection optical system 30, and includes, as shown in FIG. 10, the liquid supply port 101, the gas supply port 102, the liquid recovery port 103E, gas recovery ports 104Ea and 104Eb, and a convex 110E. The lens barrel 100E arranges the plane-parallel plate 32 between the projection optical system 30 and the wafer 40, and has a liquid supply port 106 and a liquid recovery port 107. The lens barrel 100E is different from the lens barrel 100 shown in FIG. 2 in the liquid supply port 106, liquid recovery ports 101E and 107, the gas recovery ports 104Ea and 104Eb, and the convex 110E.

The liquid supply port 106 is an opening that supplies the liquid LW, and connected to the liquid supply tube 72. The liquid supply port 106 is formed near the projection optical system 30, and has a concentric opening. The liquid recovery port 106 may be coupled with a porous member, such as sponge, or may be a slit-shaped opening. While this embodiment forms the gas recovery port 106 concentrically, it may be formed segmentally.

The liquid recovery port 107 is an opening that recovers the supplied liquid LW, and connected to the liquid recovery tube 96. The liquid recovery port 107 has a concentric opening. The liquid recovery port 107 may be coupled with a porous member, such as sponge, or may be a slit-shaped opening. While this embodiment forms the liquid recovery port 107 concentrically, it may be formed segmentally.

The liquid recovery port 103E is an opening that recovers the supplied liquid LW, and connected to the liquid recovery tube 92. The liquid recovery port 103E has a concentric opening. The liquid recovery port 103E may be coupled with a porous member, such as sponge, or may be a slit-shaped opening. The liquid recovery port 103E is formed outside the liquid supply port 101. When the liquid recovery port 103E is formed outside the liquid supply port 101, the liquid LW is less likely to leak to the outside of the projection optical system 30. While this embodiment forms the liquid recovery port 103E concentrically, it may be formed segmentally.

The fifth embodiment separates the lens barrel 100D from the liquid recovery port 103E so as to prevent the vibrations that occur in absorbing the gas PG, from transmitting to the projection optical system 30.

When a contact angle is high on the wafer 40 surface, the liquid LW spreads short when the wafer stage 45 moves, and the leakage of the liquid LW (liquid film) can be restrained without the gas recovery ports 104Ea and 104Eb shown in FIG. 9. A configuration prevents the vibrations from transmitting to the projection optical system 30 in recovering the gas PG and the liquid LW simultaneously, by enhancing the recovery capacity of the liquid recovery port 103E, and by arranging only the liquid recovery port 103E at the lens barrel 100E.

The gas recovery port 104Ea is an opening that sucks the surrounding atmosphere when the wafer stage 45 is stopped, and recovers the liquid film (or the liquid LW) leaking in the scan direction when the wafer stage 45 is moved. The gas recovery port 104Ea is connected to the gas recovery tube 94. The gas recovery port 104Ea has a concentric opening. The gas recovery port 104Ea may be coupled with a porous member, such as sponge, or may be a slit-shaped opening. The gas recovery port 104Ea is formed, as shown in FIG. 10, inside of the gas supply port 102. While this embodiment forms the gas recovery port 104Ea concentrically, it may be formed segmentally.

The gas recovery port 104Eb is an opening that recovers the supplied gas PG, and connected to the outside. The gas recovery port 104Eb recovers the evaporated liquid LW with the supplied gas PG when connected to a gas recovery tube (not shown). The gas recovery port 104Eb has a concentric opening. The gas recovery port 104Eb may be coupled with a porous member, such as sponge, or may be a slit-shaped opening. The gas recovery port 104Cb is formed, as shown in FIG. 10, inside of the gas supply port 102. While this embodiment forms the gas recovery port 104Cb concentrically, it may be formed segmentally.

The convex 110E of the fifth embodiment serves to prevent dispersions of the liquid LW. The convex 110E is formed as a separate member from the lens barrel 100E, and provided with the gas supply port 102, the liquid recovery port 103E, the gas recovery ports 104Ea and 104Eb.

Similar to the second embodiment, as the gas recovery port 104Ea starts absorbing or recovering the liquid LW, the flow velocity of the liquid LW at the gas recovery port 104Ea becomes much lower than that of the gas recovery port 104Ea that absorbs no gas PG. The liquid LW that cannot be absorbed would otherwise leak to the outside. The fifth embodiment blows the gas PG from the gas supply port 102 provided outside the gas recovery port 104Ea and restrains spread of the liquid LW (liquid film). The gas recovery port 104Eb is located between the gas recovery port 104Ea and the gas supply port 102, has a section area that does not absorb the liquid LW, and forms a channel for the gas PG. Without the gas recovery port 104Eb, as discussed above, when the gas recovery port 104Ea absorbs the liquid LW, the flow velocity of the liquid LW remarkably decreases, and most of the gas PG supplied from the gas recovery port 104Ea spreads to the outside. As a result, it is impossible to restrain spread of the leaking liquid LW (liquid film) due to the movement of the wafer stage 45.

In restraining spread of the liquid LW (liquid film) by blowing the gas PG from the gas supply port 102, the liquid LW (liquid film) disturbs and gas bubbles can occur. In this case, the generated gas bubbles are recovered with the spread-restrained liquid LW (liquid film) at the gas recovery port 104Ea. In addition, as discussed above, even when a moving direction of the wafer stage 45 inverts and the gas recovery port 104Ea cannot fully recover the gas bubbles, this configuration prevents the gas bubbles from entering the inside of the liquid supply port 101, and restrains the liquid becomes from spreading to the outside.

Similar to the first embodiment, the convex 110E when coated with or made of a liquid repellent material would reduce spread of the liquid LW beyond the convex 110E. Since the gas recovery ports 103E and 104Ea need to aggressively absorb the spreading liquid LW, they are preferably coated with or made of a hydrophilic material. Preferably, a component inside the gas recovery port 104Eb uses a hydrophilic material, and a component outside the gas recovery port 104Eb uses a liquid repellent material.

The liquid repellent material when using fluoro-resin, particularly PTFE, PFA, and silane containing perfluoro alkyl group would maintain a contact angle of 90° or greater for the liquid LW of pure water.

When the hydrophilic material uses SiO₂, SiC, stainless steel, a contact angle can be made smaller than 90° for the liquid LW of pure water.

This configuration minimizes spread of the liquid LW (liquid film) during operations of the wafer stage 45, prevents dispersions of the liquid LW, and decrease of an exposure dose due to the gas bubbles, and improves the throughput.

When the gas recovery ports 103E and 104Ea absorb the liquid LW and the gas PG simultaneously, significant vibrations occur. This embodiment separates the lens barrel 100E from the liquid recovery ports 103E and 104Ea, as shown in FIG. 10, so as not to transmit the vibrations to the projection optical system 30. Separate supporting of the liquid recovery ports 103E and 104Ea from the lens barrel 100E prevents transmissions of the vibrations to the projection optical system 30 in absorbing the liquid LW and gas PG simultaneously.

For further reductions of the vibrations, similar to the second embodiment, it is preferable to stop absorbing from the gas recovery port 104Ea and supplying the gas PG from the gas supply port 102 during exposure.

As shown in FIG. 10, the plane-parallel plate 32 can prevent contaminations of the projection optical system 30 which would otherwise occur from the wafer 40 surface during exposure.

Similar to the first embodiment, a humidifier (not shown) mixes the vapors in the gas PG, and the gas supply port 102 supplies the vapor-containing gas PG. This configuration restrains evaporation of the liquid LW, and prevents a deterioration of the exposure precision due to the evaporation heat of the liquid LW.

The liquid recovery port 103 recovers more gases than the supplied gases from the liquid supply port 101. Even when the space between the convex 110E and projection optical system 30 is used as a vent, the leaks of the vapors to the outside can be prevented.

The fifth embodiment forms the convex 110E and the projection optical system 30 as separate units. An alternate embodiment connects the convex 110D and the projection optical system 30 to each other by soft resin or flexible metal that are hard to transmit vibrations, and prevents leaks of the vapors from the liquid LW.

In this case, since the liquid recovery port 103E recovers more gases than the supply amount of the liquid LW from the liquid supply port 101, the pressure becomes negative near the liquid recovery port 103E.

When the aperture between the convex 110E and the projection optical system 30 is not closed, the liquid recovery port 103E recovers the gas through the aperture, and the bottom of the convex 110E absorbs the gas. The gas bubbles are likely to occur by absorbing the gas between the convex 110E and the projection optical system 30.

When the aperture between the convex 110E and the projection optical system 30 is closed, the bottom surface of the convex 110E absorbs lots of gas. When a distance between the bottom surface of the convex 110E and the wafer 40 is such a small distance as several hundreds μm, the flow velocity of the absorbed gas is as fast as several m/sec or greater, so that the liquid LW has an unstable interface and bubbles are likely to occur. Therefore, a gas supply/recovery pipe (not shown) is connected to a member that seals an aperture between the convex 110E and the projection optical system 30, the pressure of the gas supply/recovery pipe is measured, and the supply and recovery of the gas are controlled so that the pressure can be maintained. This configuration prevents the pressure of the convex 110E at the lens side from being negative. However, this configuration sucks the gas from the space between the convex 110E and the projection optical system 30, and the gas bubbles are likely to occur in the liquid LW.

The liquid recovery port 103E can recover the generated gas bubbles and prevents the gas bubbles from moving to the exposure area by increasing the supplied liquid amount from the liquid supply port 101. In addition, it is preferable that the recovery amount from the liquid recovery port 103E is reduced so that the gas bubbles are less likely to occur.

In exchanging the wafer 40, similar to the first embodiment, the gas supply port 102 supplies the vapor-containing gas PG, preventing evaporation of the liquid LW that remains on the final lens of the projection optical system 30. The twin-stage exposure apparatus may switch two stages continuously, and maintain the liquid LW under the final lens of the projection optical system 30.

### Sixth Embodiment

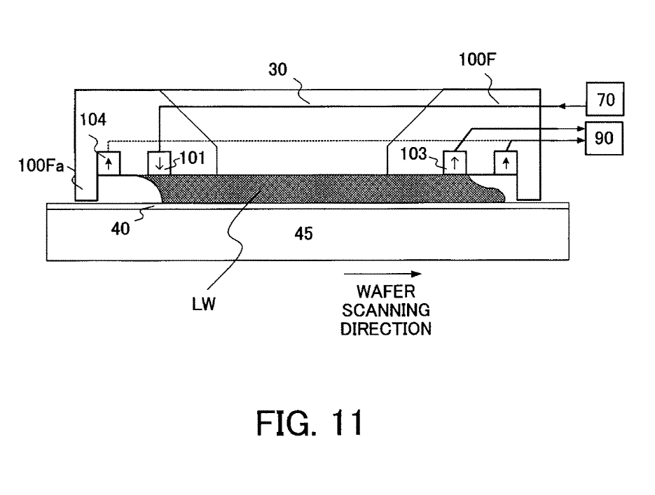

Referring now to FIG. 11, a description will be given of a lens barrel 100F as another embodiment of the lens barrel 100. Here, FIG. 11 is a schematic sectional view showing the lens barrel 100F as another embodiment of the lens barrel 100. The lens barrel 100F serves to hold the projection optical system 30, and includes, as shown in FIG. 11, the liquid supply port 101, the gas supply port 102, the liquid recovery port 103, the gas recovery port 104, and a convex 100Fa.

This embodiment can restrain the spread amount of the liquid LW by the dynamic pressure of the gas PG that flows between the convex 100Fa and the wafer 40 surface, and thus restrains the dispersions of the liquid LW from the lens barrel 100F. When the flow velocity of the gas recovery port 104 is too high, the liquid LW is absorbed with the gas PG. Therefore, a width of the gas recovery port 104 is made large, and a distance between the convex 100Fa and the wafer 40 surface is made narrow. For example, it is preferable to set the flow velocity enough to restrain the spread amount of the liquid LW instead of absorbing the liquid LW from the gas recovery port 104.

Similar to the first embodiment, the convex 110Fa when coated with or made of a liquid repellent material would reduce spread of the liquid LW beyond the convex 110Fa.

The liquid repellent material when using fluoro-resin, particularly PTFE, PFA, and silane containing perfluoro alkyl group would maintain a contact angle of 90° or greater for the liquid LW of pure water.

The sixth embodiment arranges the gas recovery port 104 to the lens barrel 100F so as to enclose the projection optical system 30, and the arrangement may be continuous or segmental. The gas recovery amount may be controlled in accordance with a moving direction of the wafer stage 45.

In this case, as described above, the liquid recovery port 103 absorbs more gases than the liquid supply port 101. The pressure of the convex 100Fa at the lens side becomes negative and the bottom surface of the convex 100Fa sucks lots of gases. When a distance between the bottom surface of the convex 100Fa and the wafer 40 is such a small distance as several hundreds μm, the flow velocity of the absorbed gas is as fast as several m/sec or greater, so that the liquid LW has an unstable interface and bubbles are likely to occur.

Therefore, as shown in FIG. 21, a vent 104Fc is provided between the convex 100Fa and the gas recovery port 104, to prevent the pressure of the convex 100Fa at the lens side from being negative. When the vent 104Fc is provided, most of the gas recovered by the gas recovery port 104 is the gas through the vent 104Fc, and the recovery capacity of the liquid LW lowers. Accordingly, the convex 100Fa when coated with or made of a liquid repellent material would reduce spread of the liquid LW due to the movement of the wafer stage 45.

The liquid repellent material when using fluoro-resin, particularly PTFE, PFA, and silane containing perfluoro alkyl group would maintain a contact angle of 90° or greater for the liquid LW of pure water.

As discussed for the first embodiment, there is provided the adjustment mechanism 190 that adjusts a distance between the convex 110Fa and the wafer 40. The adjustment mechanism 190 adjusts a distance between them in exposing the wafer 40, so that the spreading liquid LW does not contact the convex 110Fa. This configuration reduces a contact between the liquid LW and the convex 100Fa, and maintains the exposure precision.

### Seventh Embodiment

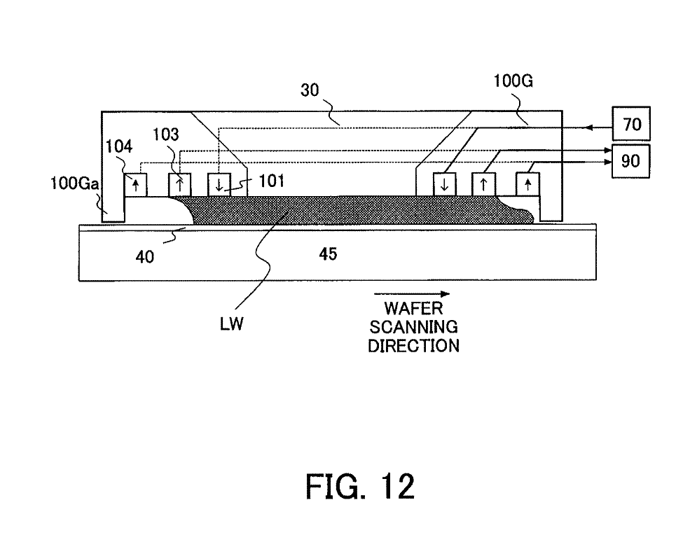

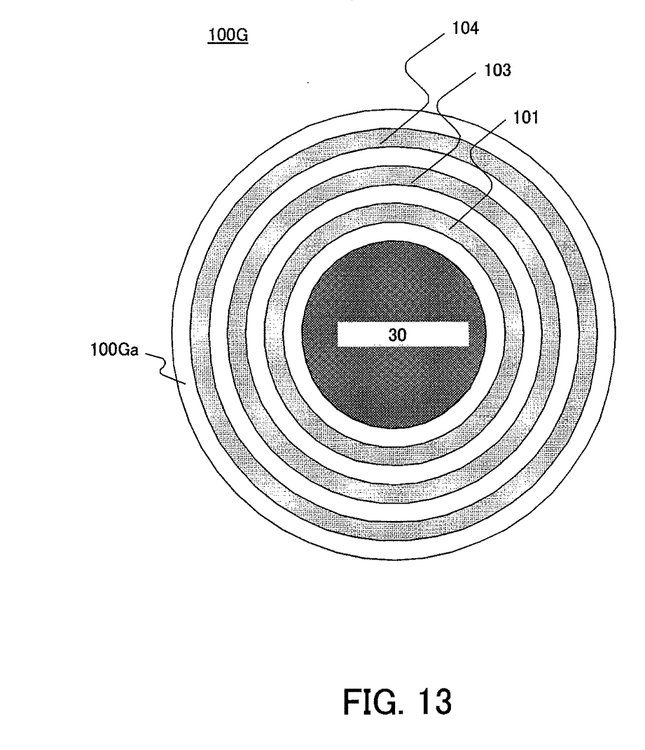

Referring now to FIG. 12, a description will be given of a lens barrel 100G as another embodiment of the lens barrel 100. Here, FIG. 12 is a schematic sectional view showing the lens barrel 100G as another embodiment of the lens barrel 100. The lens barrel 100G serves to hold the projection optical system 30, and includes, as shown in FIG. 12, the liquid supply port 101, the liquid recovery port 103, the gas recovery port 104, and a convex 100Ga. FIG. 12 is a bottom sectional view of the lens barrel 100G.

The seventh embodiment does not form a gas supply port, sucks the gas from the gas recover port 104, and restrains the spread amount of the liquid LW by the dynamic pressure of the gas PG that flows between the convex 100Ga and the wafer 40 surface.

The convex 110Ga when coated with or made or a liquid repellent material would reduce spread of the liquid LW beyond the convex 110Ga. This configuration makes dispersions of the liquid LW smaller than nonuse of the liquid repellent material.

The liquid repellent material when using fluoro-resin, particularly PTFE, PFA, and silane containing perfluoro alkyl group would maintain a contact angle of 90° or greater for the liquid LW of pure water.

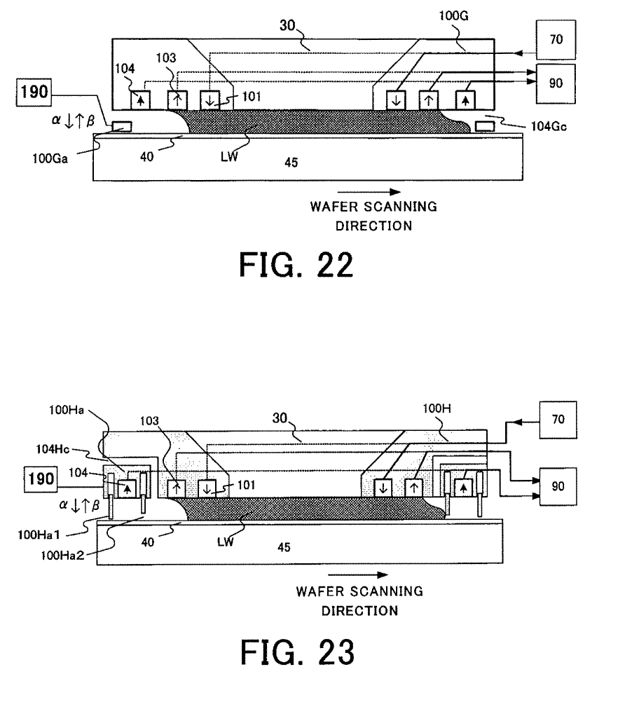

The seventh embodiment, similar to the first embodiment, the liquid recovery port 103 absorbs more gases than the liquid supply port 101. The pressure of the convex 100Ga at the lens side becomes negative and the bottom surface of the convex 100Ga sucks lots of gases. When a distance between the bottom surface of the convex 100Ga and the wafer 40 is such a small distance as several hundreds μm, the flow velocity of the absorbed gas is as fast as several m/sec or greater, so that the liquid LW has an unstable interface and bubbles are likely to occur. Therefore, as shown in FIG. 22, a vent 104Gc is provided between the convex 100Ga and the gas recovery port 104, to prevent the pressure of the convex 100Ga at the lens side from being negative.

When the vent 104Gc is provided, most of the gas recovered by the gas recovery port 104 is the gas through the vent 104Gc and the recovery capacity of the liquid LW lowers. Accordingly, the convex 100Ga when coated with or made of a liquid repellent material would reduce spread of the liquid LW due to the movement of the wafer stage 45.

The liquid repellent material when using fluoro-resin, particularly PTFE, PFA, and silane containing perfluoro alkyl group would maintain a contact angle of 90° or greater for the liquid LW of pure water.

As discussed for the above embodiment, the adjustment mechanism 190 adjusts a distance between the convex 110Ga and the wafer 40. The adjustment mechanism 190 adjusts a distance between them in exposing the wafer 40, so that the spreading liquid LW does not contact the convex 110Ga. This configuration reduces a contact between the liquid LW and the convex 100Ga, and maintains the exposure precision.

### Eighth Embodiment

Referring now to FIG. 23, a description will be given of a lens barrel 100H as another embodiment of the lens barrel 100. Here, FIG. 23 is a schematic sectional view showing the lens barrel 100H as another embodiment of the lens barrel 100. The lens barrel 100H serves to hold the projection optical system 30, and includes, as shown in FIG. 23, the liquid supply port 101, the liquid recovery port 103, the gas recovery port 104, and a convex 100Ha. Diaphragms 100Ha1 and 100Ha2 are arranged to enclose the gas recovery port 104 of the convex 100Ha at the wafer 40 side.

This embodiment does not form a gas supply port, sucks the gas from the gas recover port 104, and the spreading liquid LW via channels enclosed by the diaphragms 100Ha1 and 100Ha2.

The diaphragms 100Ha1 and 100Ha2 when coated with or made of a liquid repellent material would reduce spread of the liquid LW beyond them. This configuration makes dispersions of the liquid LW smaller than nonuse of the liquid repellent material.

The liquid repellent material when using fluoro-resin, particularly PTFE, PFA, and silane containing perfluoro alkyl group would maintain a contact angle of 90° or greater for the liquid LW of pure water.

The eighth embodiment, similar to the above embodiment, the liquid recovery port 103 absorbs more gases than the liquid supply port 101. The pressure of the convex 100Ha at the lens side becomes negative and the bottom surface of the convex 100Ha sucks lots of gases. When a distance between the bottom surface of the convex 100Ha and the wafer 40 is such a small distance as several hundreds μm, the flow velocity of the absorbed gas is as fast as several m/sec or greater, so that the liquid LW has an unstable interface and bubbles are likely to occur. Therefore, as shown in FIG. 23, a vent 104Hc is provided between the convex 100Ha and the gas recovery port 104, to prevent the pressure of the convex 100Ha at the lens side from being negative.

As discussed for the above embodiment, the adjustment mechanism 190 adjusts a distance between each of the diaphragms 100Ha1 and 100Ha2 and the wafer 40. In exposing the wafer 40, the adjustment mechanism 190 raises the diaphragms 100Ha1 and 100Ha2 in direction so that the spreading liquid LW does not contact the diaphragms 100Ha1 and 100Ha2.

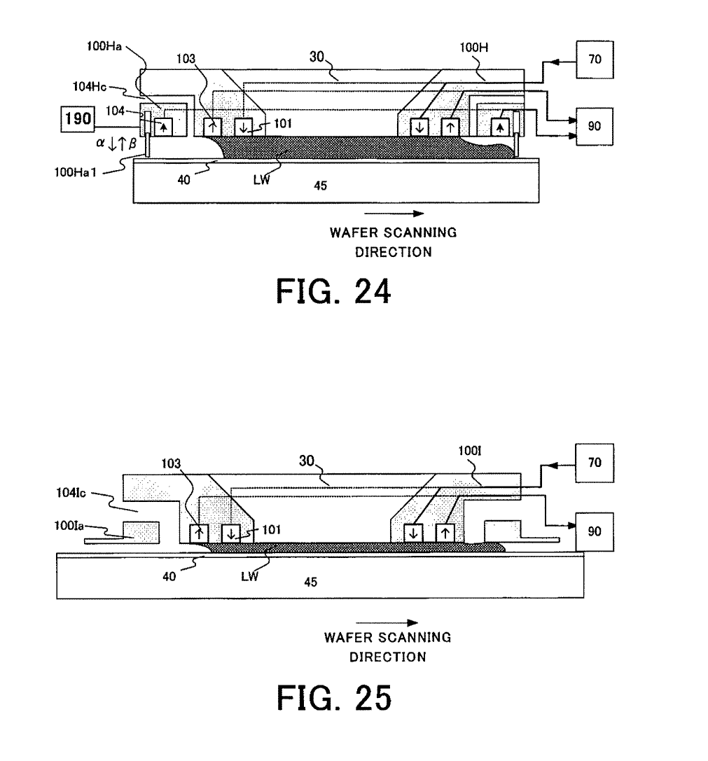

In moving the wafer stage 45 by a long distance, the diaphragms 100Ha1 and 100Ha2 are fallen in direction, the adjustment mechanism 190 adjusts a distance between the convex 100Ha and the wafer 40, and restrains spread of the liquid LW. This configuration reduces the contacts between the liquid LW and each of the diaphragms 100Ha1 and 100Ha2, and maintains the exposure precision. Alternatively, a configuration shown in FIG. 24 that provides only the diaphragm 100Ha1 to the convex 100Ha at the wafer 40 side can restrain spread of the liquid LW.

For a small distance between the projection optical system 30 and the wafer 40, a convex 100Ia can restrain spread of the liquid LW when the convex 100Ia is set with a distance to the wafer 40 equal to or greater than the distance between the projection optical system 30 and the wafer 40, as shown in FIG. 25. Even in FIG. 25, the liquid recovery port 103 absorbs more gases than the liquid supply port 101, and the pressure of the convex 100Ia at the lens side becomes negative. When a distance between the bottom surface of the convex 100Ia and the wafer 40 is such a small distance as several hundreds μm, the flow velocity of the gas between the bottom surface of the convex 100Ia and the wafer 40 is as fast as several m/sec or greater, so that the liquid LW has an unstable interface and bubbles are likely to occur. Therefore, a vent 104Ic is provided between the convex 100Ia and the gas recovery port 103, to prevent the pressure of the convex 100Ia at the lens side from being negative.

The convex 100Ia when coated with or made of a liquid repellent material would reduce dispersions of the liquid LW from the convex 100Ia. When the convex 100Ia provided with a gas recovery port (not shown) can further reduce the dispersions of the liquid LW.

The liquid repellent material when using fluoro-resin, particularly PTFE, PFA, and silane containing perfluoro alkyl group would maintain a contact angle of 90° or greater for the liquid LW of pure water.

### Ninth Embodiment

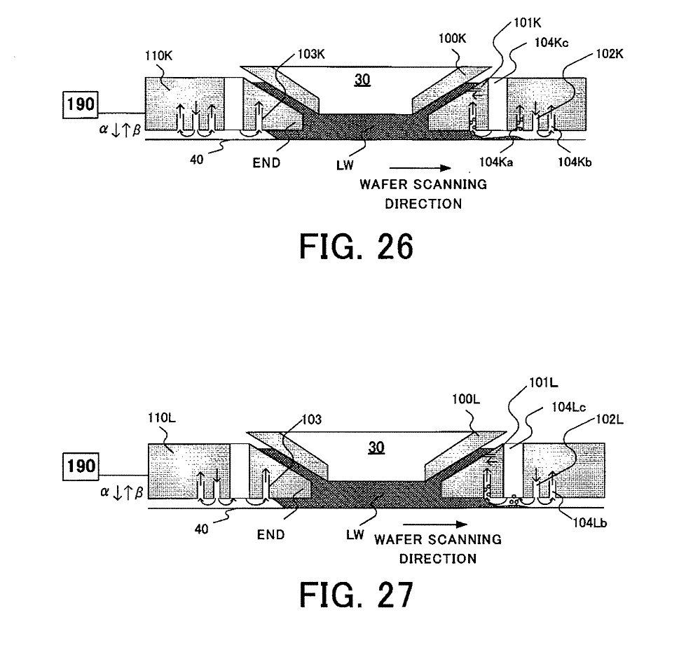

Referring now to FIGS. 26 and 27, a description will be given of the lens barrels 100K and 100L as another embodiment of the lens barrel 100. Here, FIG. 26 is a schematic sectional view of the lens barrel 100K as another embodiment of the lens barrel 100.

The convex 110K of the ninth embodiment serves to reduce dispersions of the liquid LW. The convex 110K is provided as a separate member from the lens barrel 100K, and includes a gas supply port 102K and gas recovery ports 104Ka and 104Kb. The convex 110K further includes a liquid recovery port 103K, a vent 104Kc connected to the upper space of the convex 110K, and the liquid supply port 101K.

The liquid is supplied from the liquid supply port 101K, fills the space between the projection optical system 30 and the wafer 40, and is recovered by the liquid recovery port 103K.

The gas recovery port 104Ka is an opening that sucks gas supplied from the gas supply port 102K when the wafer stage 45 is stopped, and recovers the liquid film (or the liquid LW) leaking in the scan direction when the wafer stage 45 is moved. The gas recovery port 104Ka is connected to a gas recovery tube (not shown). The gas recovery port 104Ka has a concentric opening. The gas recovery port 104Ka may be coupled with a porous member, such as sponge, or may be a slit-shaped opening. The gas recovery port 104Ka is formed inside of the gas supply port 102K. While this embodiment forms the gas recovery port 104Ka concentrically, it may be formed segmentally.

The gas recovery port 104Kb is an opening that sucks gas supplied from the gas supply port 102K, and is connected to a gas recovery tube (not shown). The gas recovery port 104Kb recovers the supplied gas PG and the evaporated liquid LW. The gas recovery port 104Ka has a concentric opening in this embodiment. The gas recovery port 104Ka may be coupled with a porous member, such as sponge, or may be a slit-shaped opening. The gas recovery port 104Kb is formed inside of the gas supply port 102K. While this embodiment forms the gas recovery port 104Kb concentrically, it may be formed segmentally.

As the wafer stage 45 starts moving, the liquid LW starts leaking in the moving direction. The liquid LW passes under the vent 104Kc, and is recovered by the gas recovery port 104Ka. The dynamic pressure of the gas supplied from the gas supply port 102K restrains the liquid LW that could not be recovered. This configuration thus restrains the leakage of the liquid LW due to the movements of the wafer stage 45.

In restraining spread of the liquid LW (liquid film) by blowing the gas PG from the gas supply port 102K, the liquid LW (liquid film) disturbs and gas bubbles can occur. In this case, the gas recovery port 104Ka recovers the generated gas bubbles with the spread-restrained liquid LW (liquid film).

The lens bubble 100K arranges the liquid recovery port 103K outside the end of the convex 110K. Even when a moving direction of the wafer stage 45 inverts and the gas recovery port 104Ka cannot fully recover the gas bubbles, the liquid LW flows from the end to the liquid recovery port 103 provided outside, preventing the gas bubbles generated outside the end from entering the inside.

Similar to the above embodiment, the convex 110K when coated with or made of a liquid repellent material would reduce spread beyond the convex 110K. This configuration makes dispersions of the liquid LW smaller than nonuse of the liquid repellent material. Since the liquid recovery port 103K and the gas recovery port 104K need to aggressively absorb the spreading liquid LW, a hydrophilic material is preferably applied to the liquid recovery port 103K, the gas recovery port 104K, and their vicinity. Preferably, a component inside the gas recovery port 104Ka uses a hydrophilic material, and a component outside the gas recovery port 104Ka uses a liquid repellent material.

The liquid repellent material when using fluoro-resin, particularly PTFE, PFA, and silane containing perfluoro alkyl group would maintain a contact angle of 90° or greater for the liquid LW of pure water.

When the hydrophilic material uses SiO₂, SiC, stainless steel, a contact angle can be made smaller than 90° for the liquid LW of pure water.

This configuration minimizes spread of the liquid LW (liquid film) during operations of the wafer stage 45, prevents dispersions of the liquid LW, and decrease of an exposure dose due to the gas bubbles, and improves the throughput.

When the liquid recovery port 103K and the gas recovery port 104Ka absorb the liquid LW and the gas PG simultaneously, significant vibrations occur. The ninth embodiment separates the lens barrel 100K from the convex 110K so as not to transmit the vibrations to the projection optical system 30. Separate supporting of the convex 110K from the projection optical system 30 prevents transmissions of the vibrations to the projection optical system 30 in absorbing the liquid LW and gas PG simultaneously. For further reductions of the vibrations, it is preferable to stop, during exposure, absorbing from the gas recovery ports 104Ka 104Kb and supplying the gas PG from the gas supply port 102K.

When the supply and recovery of the gas PG stop, during exposure, in order to restrain the vibrations of the convex 110K, the liquid LW spreads along with the movement of the wafer stage if a contact angle of the resist applied to the wafer 40 plane is small. Therefore, when a distance between the convex 110c and the wafer 40 is so small as 0.5 mm or smaller, the liquid LW gets in a space between the convex 110K and the wafer 40 and the liquid LW contacts the convex 110K. This contact deforms the liquid LW, and fluctuates the pressure applied on the wafer 40 plane greater than several hundreds Pa, affects the control performance of the stage, and possibly deteriorates the exposure accuracy. This embodiment has an adjustment mechanism 190 that adjusts a distance between the convex 110K and the wafer 40. The adjustment mechanism 190 adjusts the distance between the convex 110K and the wafer 40 so that the spreading liquid LW does not contact the convex 110K in stopping supply and recovery of the gas PG. In other words, the adjustment mechanism 190 serves to adjust distances between each of the gas recovery ports 104Ka and 104Kb and the wafer 40. The adjustment mechanism 190 adjusts the convex 110K in a direction (of arrow) shortening distances between each of the gas recovery ports 104Ka and 104Kb and the wafer 40 when the gas recovery ports 104Ka and 104Kb recover the gas PG. The adjustment mechanism 190 adjusts the convex 110K in a direction (of arrow prolonging the distances between each of the gas recovery ports 104Ka and 104Kb and the wafer 40 except when the gas recovery ports 104Ka and 104Kb recover the gas PG. This configuration prevents contact between the liquid LW and the convex 110K, and maintains the exposure accuracy.

Similar to the first embodiment, a humidifier (not shown) mixes the vapors in the gas PG, and the gas supply port 102K supplies the vapor-containing gas PG. This configuration can restrain the evaporation of the liquid LW, and prevent a deterioration of the exposure precision due to the evaporation heat of the liquid LW.

Actually, the liquid recovery port 103K recovers more gases than the supplied gases from the liquid supply port 101K. The vent 104Kc in the convex 110K sucks the surrounding atmosphere of the projection optical system 30, restraining the leaks of the evaporated liquid LW.

While this embodiment provides the convex 110K with the vent 104Kc, the present invention may close the vent 104Kc to prevent the vapors of the liquid LW from leaking and spreading around the projection optical system 30.

Therefore, a gas supply/recovery pipe (not shown) is connected to the vent 104Kc, the pressure of the gas supply/recovery pipe is measured, and the supply and recovery of the gas are controlled so that the pressure can be maintained. This configuration prevents the pressure of the convex 110K at the lens side from being negative.

In exchanging the wafer 40, similar to the first embodiment, the gas supply port 102K supplies the vapor-containing gas PG, preventing evaporation of the liquid LW that remains on the final lens of the projection optical system 30. The twin-stage exposure apparatus may switch two stages continuously, and maintain the liquid LW under the final lens of the projection optical system 30.

FIG. 27 shows another embodiment that is different from the embodiment shown in FIG. 26 in that FIG. 27 does not have the gas recovery port 104K shown in FIG. 26.

In FIG. 26, the gas recovery port 104Ka starts absorbing and recovering the liquid when the liquid LW leaks as the wafer stage 45 moves. When the gas recovery port 104Ka sucks the liquid LW, the flow velocity of the gas recovery port 104Ka becomes remarkably lower than that in which only the gas PG is sucked. Therefore, the gas supplied from the gas supply port 102K starts flowing only to the outside, and the flow LW that cannot be absorbed attempts to further leak to the outside.

However, FIG. 27 maintains a large aperture size of the vent 104Lc provided in the gas supply port 102L at the lens side, and prevents clogging of the liquid film that spreads as the stage moves. Since the gas flow from the gas supply port 102L does not significantly change, the spread of the liquid LW (liquid film) is restrained.

The gas supply amount from the gas supply port 102L can be easily increased up to about several hundreds L/min by increasing the pressure of a gas supply source (not shown). However, when the gas recovery port 104Lc is connected to the gas supply/recovery pipe (not shown), a maximum gas recovery amount is restricted by the length and the internal diameter of the pipe and such a large recovery amount as several hundreds L/min is difficult to achieve. Preferably, the gas recovery port 104Lc is used as a vent when a larger gas supply amount is needed to facilitate spread of the liquid LW to the outside. Use of the gas recovery port 104Lc as the vent would restrain an increase of the pressure of the convex 110L at the lens side.

In exposure, the illumination optical system 14 e.g., Koehler-illuminates the reticle 20 using the light emitted from the light source unit 12. The light that passes the reticle 20 and reflects the reticle pattern is imaged on the wafer 40 by the projection optical system 30 and the liquid LW. Since the exposure apparatus 1 arranges the liquid recovery port 103 outside the liquid supply port 101, the liquid LW becomes less likely to spread. The evaporation of the liquid LW is restricted by including vapor in the gas PG that encloses the liquid LW. The exposure apparatus 1 prevents the gas bubbles from mixing in the liquid LW and from evaporating from the liquid LW, maintains the throughput and exposure accuracy, and provides devices (such as semiconductor devices, LCD devices, image pickup devices (such as CCDs), and thin film magnetic heads).

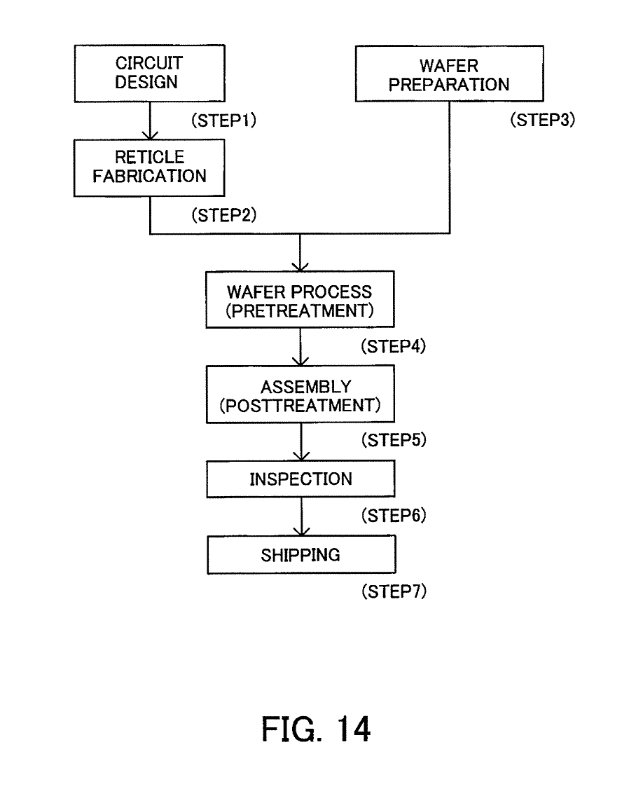

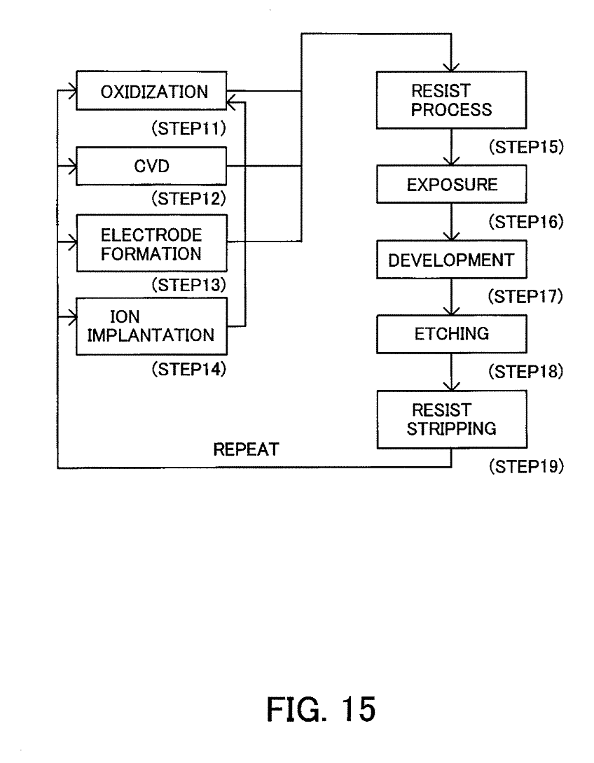

Referring now to FIGS. 14 and 15, a description will be given of an embodiment of a device manufacturing method using the above exposure apparatus 1. FIG. 14 is a flowchart for explaining how to fabricate devices (i.e., semiconductor chips such as IC and LSI, LCDs, CCDs, and the like). Here, a description will be given of the fabrication of a semiconductor chip as an example. Step 1 (circuit design) designs a semiconductor device circuit. Step 2 (reticle fabrication) forms a reticle having a designed circuit pattern. Step 3 (wafer preparation) manufactures a wafer using materials such as silicon. Step 4 (wafer process), which is also referred to as a pretreatment, forms actual circuitry on the wafer through lithography using the mask and wafer. Step 5 (assembly), which is also referred to as a posttreatment, forms into a semiconductor chip the wafer formed in Step 4 and includes an assembly step (e.g., dicing, bonding), a packaging step (chip sealing), and the like. Step 6 (inspection) performs various tests for the semiconductor device made in Step 5, such as a validity test and a durability test. Through these steps, a semiconductor device is finished and shipped (Step 7).

FIG. 15 is a detailed flowchart of the wafer process in Step 4. Step 11 (oxidation) oxidizes the wafer's surface. Step 12 (CVD) forms an insulating film on the wafer's surface. Step 13 (electrode formation) forms electrodes on the wafer by vapor disposition and the like. Step 14 (ion implantation) implants ions into the wafer. Step 15 (resist process) applies a photosensitive material onto the wafer. Step 16 (exposure) uses the exposure apparatus 1 to expose a circuit pattern of the reticle onto the wafer. Step 17 (development) develops the exposed wafer. Step 18 (etching) etches parts other than a developed resist image. Step 19 (resist stripping) removes disused resist after etching. These steps are repeated, and multi-layer circuit patterns are formed on the wafer. Use of the manufacturing method in this embodiment helps fabricate higher-quality devices than ever. The device manufacturing method that uses the exposure apparatus 1 and resultant devices constitute one aspect of the present invention.

Further, the present invention is not limited to these preferred embodiments, and various variations and modifications may be made without departing from the scope of the present invention.

This application claims a foreign priority benefit based on Japanese Patent Applications Nos. 2005-057895, filed on Mar. 2, 2005, 2005-158417, filed on May 31, 2005, 2005-380283, filed on Dec. 28, 2005, 2006-026250, filed on Feb. 2, 2006, each of which is hereby incorporated by reference herein in its entirety as if fully set forth herein.

1. An exposure apparatus for immersing, in liquid, a space between a final lens of a projection optical system and a plate, and for exposing the plate via the liquid, said exposure apparatus comprising:
a convex part for reducing or preventing a leak of the liquid from an area in which the liquid is to be filled between the final lens and the plate, a liquid recovery port being provided closer to the final lens than said convex part, and configured to recover the liquid from the area; and
a pressure maintainer for restraining a pressure fluctuation of gas between the liquid recovery port and said convex part.

2. An exposure apparatus according to claim 1, wherein the liquid recovery port is able to recover the gas in the area.

3. An exposure apparatus according to claim 6, wherein said leak reducer includes at least one of a convex part and a gas curtain producer for keeping the liquid in the area.

4. An exposure apparatus according to claim 1, further comprising
a liquid recoverer, provided in said leak producer part, for recovering the liquid that has leaked from the area.

5. An exposure apparatus according to claim 1, wherein said pressure maintainer includes at least one of a vent for connecting the gas in the area to an atmosphere outside of the area, a gas supplier for supplying the gas to the area, and a pressure controller for supplying the gas to and recovering the gas from the area.

6. An exposure apparatus for immersing, in liquid, a space between a final lens of a projection optical system and a plate, and for exposing the plate via the liquid, said exposure apparatus comprising:
a leak reducer for reducing or preventing a leak of the liquid from an area in which the liquid is to be filled between the final lens and the plate, a liquid recovery port being provided closer to the final lens than said leak reducer, and configured to recover the liquid from the area;
a pressure maintainer for restraining a pressure fluctuation of gas between said liquid recover port and said leak reducer;
a first housing that has the liquid supply port; and
a second housing separated and spaced from said first housing, and equipped with said leak reducer.

7. An exposure apparatus for immersing, in liquid, a space between a final lens of a projection optical system and a plate, and for exposing the plate via the liquid, said exposure apparatus comprising;
a leak reducer for reducing or preventing a leak of the liquid from an area in which the liquid is to be filled between the final lens and the plate, a liquid recovery port being provided closer to the final lens than said leak producer, and configured to recover the liquid from the area;
a first housing that has the liquid supply port;
a second housing separated and spaced from said first housing, and equipped with said leak reducer; and
an adjuster for adjusting a distance between said plate and at least part of said second housing.

8. An exposure apparatus according to claim 3, wherein said gas curtain producer stops supplying and recovering the gas when the plate is being exposed.

9. An exposure apparatus according to claim 7, wherein said adjuster adjusts the distance such that the distance between of said second housing and the plate when the plate is being exposed is longer than that when the plate is not exposed.

10. An exposure apparatus according to claim 3, wherein said gas curtain producer supplies vapor made of the same material as the liquid or a material evaporated from the liquid.

11. An exposure apparatus according to claim 4, wherein said convex part is at least partially made of a liquid repellent material, and an internal surface and a vicinity of a recovery port of said liquid recoverer are made of a liquid hydrophilic material.

12. A device manufacturing method comprising the steps of:
exposing a plate using an exposure apparatus according to claim 1; and
developing the plate that has been exposed.

13. An exposure apparatus according to claim 1, wherein said convex part is arranged closer to said plate than said liquid recovery port.

14. An exposure apparatus according to claim 7, further comprising a pressure maintainer that is provided between said first housing and said second housing, and configured to restrain a pressure fluctuation of gas between the liquid recovery port and the leak reducer.
